(19) United States
(12) Patent Application Publication
(10) Pub. No.: US 2009/0147200 A1
(43) Pub. Date: Jun. 11, 2009

(54) VERTICAL ALIGNMENT FILM AND METHOD OF MANUFACTURING THEREOF, VERTICAL ALIGNMENT SUBSTRATE AND METHOD OF MANUFACTURING THEREOF, AND LIQUID CRYSTAL DISPLAY DEVICE

(75) Inventors: Kentaro Okuyama, Miyagi (JP); Tatsuo Uchida, Miyagi (JP); Tetsuya Miyashita, Miyagi (JP)

Correspondence Address: K&L Gates LLP, P. O. BOX 1135, CHICAGO, IL, 60690, US

(73) Assignees: Sony Corporation, Tokyo (JP); Tohoku University, Miyagi (JP)

(21) Appl. No.: 12/327,585

(22) Filed: Dec. 3, 2008

(30) Foreign Application Priority Data
Dec. 4, 2007 (JP) 2007-313200

(51) Int. Cl. G02F 1/1337

(52) U.S. Cl. 349/127; 349/187

(57) ABSTRACT

A highly reliable vertical alignment film for aligning display-use liquid crystal molecules in a direction slightly tilted from the substrate normal line direction and a method of manufacturing the vertical alignment film are provided. A layer composed of a liquid crystalline monomer that has a crystalline framework, and that has characteristics to align the crystalline framework vertically to an interface with a dissimilar material and polymerizable characteristics is formed on a transparent substrate. A magnetic field is applied thereto while the liquid crystal state is maintained, and thereby the liquid crystalline framework of the liquid crystalline monomer is aligned in a direction slightly tilted from the normal line direction of the substrate. In this state, the liquid crystalline monomer is polymerized, and a hardened layer formed from a complex composed of the unreacted liquid crystalline monomer and a liquid crystalline monomer polymer is formed as a vertical alignment film.

### CROSS REFERENCES TO RELATED APPLICATIONS

The present application claims priority to Japanese Patent Application JP 2007-313200 filed in the Japanese Patent Office on Dec. 4, 2007, the entire contents of which is being incorporated herein by reference.

### BACKGROUND

The present disclosure relates to a vertical alignment film for controlling alignment of display-use liquid crystal molecules in a liquid crystal display device and a method of manufacturing the vertical alignment film, a vertical alignment substrate including the vertical alignment film and a method of manufacturing the vertical alignment substrate, and a liquid crystal display device.

Currently, a liquid crystal display unit is widely used as a display section for an electronic device such as a mobile phone and a liquid crystal television or as a display unit for a personal computer (PC). A transmissive liquid crystal display unit generally used as a full color display unit is composed of a transmissive liquid crystal display device including a color filter (liquid crystal display panel) and a backlighting unit that irradiates the rear face side with white color. In the transmissive liquid crystal display unit, an image is displayed by controlling a transmission factor of the irradiated light passing the liquid crystal display device.

FIG. 16 is a partial cross sectional view showing a basic structure of an existing liquid crystal display device. In a liquid crystal display device 100, a liquid crystal cell 105 is formed from a liquid crystal layer 101 and a pair of transparent substrates 102a and 102b oppositely arranged with the liquid crystal layer 101 in between. On the outer face sides of the transparent substrates 102a and 102b, a pair of polarization plates 106a and 106b is respectively arranged.

The transparent substrates 102a and 102b are made of a glass substrate or the like. On the inner face side of the transparent substrate 102a, a transparent electrode 103a an alignment film 104a and the like are formed. On the inner face side of the transparent substrate 102b, an (not-shown) color filter composed of three primary colors R (red), G (green), and B (blue), a transparent electrode 103b, an alignment film 104b and the like are formed. The transparent electrode 103a and the transparent electrode 103b are composed of, for example, ITO (Indium Tin Oxide) or the like. The alignment film 104a and the alignment film 104b are provided to be contacted with the liquid crystal layer 101.

The polarization plates 106a and 106b are respectively made of a polarization film and two pieces of transparent protective films or the like. The polarization film is generally made of a uniaxially-stretched polyvinyl alcohol film or the like; and iodine, a dichroic dye or the like that is held by the film. On the both sides thereof, as the transparent protective film, a TAC (triacetyl cellulose) film or the like is bonded.

In the liquid crystal display device 100, when an electric field is not applied, liquid crystal molecules of the liquid crystal layer 101 are kept in a state of specific regular alignment between the transparent substrates 102a and 102b. By applying an electric field to the liquid crystal molecules, the alignment state of the liquid crystal molecules is changed, and the light transmission factor of the liquid crystal display device 100 is changed. Therefore, one of the keys to determine the quality of the liquid crystal display device is the alignment technology to keep the liquid crystal molecules in a state of specific alignment when an electric field is not applied.

According to differences in the foregoing alignment technology, a method of changing the alignment state of the liquid crystal molecules by an electric field and the like, various modes exist for the liquid crystal display device 100. For example, TN (Twisted Nematic) mode, EPS (In-Plane Switching mode), ECB (Electrically Controlled Birefringence) mode, OCB (Optically Compensatory Bend) mode, VA (Vertical Alignment) mode and the like have been proposed (for example, refer to “Color TFT liquid crystal display (revised version),” edited and supervised by Teruhiko Yamazaki, Hideaki Kawakami, and Hiroo Hori, Kyoritsu Shuppan Co., Ltd. (2005)).

FIG. 17A is an explanation view showing an alignment technology used in TN mode, IPS mode, ECB mode, OCB mode and the like. FIG. 17A shows an alignment state of liquid crystal molecules that are contacted with a horizontal alignment film 114 and are homogeneous-aligned to the horizontal alignment film 114. In these operation modes, when an electric field is not applied, the horizontal alignment film 114 horizontally aligns the long axis direction of liquid crystal molecules 110 contacted therewith so that the long axis direction of the liquid crystal molecules 110 are almost in parallel with a face of the transparent substrate 102 and are ordered in a certain direction. In this case, as shown in FIG. 17A, it is important that the alignment direction of the liquid crystal molecules 110 that are horizontally aligned is slightly tilted to the substrate face (pretilted). If pretilted, it is possible to prevent reverse tilt that the liquid crystal molecules 110 are tilted in the opposite direction when an electric field is applied, and to realize favorable operation characteristics and favorable optical characteristics as a liquid crystal display device.

In the foregoing respective operation modes, the horizontal alignment film 114 is essential. The horizontal alignment film 114 currently used widely is formed by forming an organic polymer resin film composed of polyimide or the like on a substrate and providing rubbing treatment to strongly rub the surface thereof in a certain direction with the use of a cloth made of rayon, nylon or the like. In relation to the polymer resin film provided with the rubbing treatment, the liquid crystal molecules 110 are aligned so that the long axis direction is in parallel with the rubbing direction. The polyimide film is suitably used, since therewith a pretilt angle of about several degree is obtained by the rubbing treatment.

However, in the rubbing treatment, minute dust is generated from the rubbing cloth, the polymer resin film and the like. The dust may cause a defect of the liquid crystal display device, and necessitates a washing step, a drying step and the like to remove the dust, resulting in increasing the number of manufacturing steps. Further, in the rubbing treatment, static electrical charge is generated, and thus, for example, in the case of an active matrix liquid crystal display unit, a semiconductor device such as thin film transistor may be destroyed. Further the pretilt angle capable of being realized by the rubbing treatment is limited to a narrow range by the material characteristics of the polymer resin. To realize a reproducible pretilt angle, it is necessary to precisely control the rubbing state.

Therefore, methods of manufacturing the horizontal alignment film not using the rubbing treatment have been proposed. For example, in the following Japanese Unexamined Patent Application Publication No. 2-43517 (pp. 2-5), a method of manufacturing a liquid crystal-use alignment film has been proposed. In the method, a main chain type liquid crystal polymer is kept in a state of liquid crystal and is exposed in a parallel magnetic field. The main chains are aligned, and then major part of the alignment state is solidified by a subsequent given treatment. Thereby, a horizontal alignment film suitable for STN (Super TN) mode is formed. “Main chain type” herein represents a type in which a mesogenic group contributing to formation of the liquid crystal state exists in the main chain of a molecule. “Liquid crystal polymer” includes thermotropic liquid crystal that shows liquid crystal state in a certain temperature range at the melting point or more and lyotropic liquid crystal that shows liquid crystal state in the case where it is melted in an appropriate solvent in high concentration.

In the method of Japanese Unexamined Patent Application Publication No. 2-43517, in the case where the main chain type liquid crystal polymer is the thermotropic liquid crystal, after a layer composed of the liquid crystal polymer is formed on a substrate, the liquid crystal polymer layer is heated up to an appropriate temperature of the melting point or more to obtain the liquid crystal state. In this state, the liquid crystal polymer layer is exposed in the parallel magnetic field for a given time. After the main chains are aligned, temperature of the liquid crystal polymer layer is lowered to the level under the melting point. Then, while the alignment state is maintained as much as possible, the liquid crystal polymer layer is solidified.

Meanwhile, in the case where the main chain type liquid crystal polymer is the lyotropic liquid crystal, after the liquid crystal polymer is dissolved in an appropriate solvent, the solution is arranged on the substrate by a method such as coating, and a solution layer in which the liquid crystal polymer is in a state of liquid crystal state is formed. In this state, the liquid crystal polymer is exposed in the parallel magnetic field for a given time. After the main chains are aligned, the solvent is evaporated from the solution layer to precipitate the liquid crystal polymer. Then, the liquid crystal polymer is solidified while the alignment state is maintained as much as possible.

In Example 1 of Japanese Unexamined Patent Application Publication No. 2-43517, an example in which a horizontal alignment film expressing a pretilt angle of 35 to 37 degree was obtained when a magnetic field was applied so that an angle made by the substrate face and flux became 45 degree is shown. As another example, an example in which a horizontal alignment film expressing a pretilt angle of 25 to 47 degree was obtained when a magnetic field was applied so that an angle made by the substrate face and flux becomes 30 to 50 degree is described. Further, it is therein described that in the case where the alignment film is composed of non-orientational polymer and main chain type liquid crystal polymer, which are formed in a phase separation fashion so that a single phase size becomes about 1 μm or less, the alignment of the main chain type liquid crystal polymer molecules tend to be more uniform.

Further, in the following Japanese Patent No. 3572787 (pp. 4, 5, 7, and 8, particularly paragraph 0009 and FIG. 3), a technology to express a pretilt angle of about 10 degree in a reproducible fashion is proposed, and a method of manufacturing a liquid crystal cell using such a technology is proposed. In the method of manufacturing a liquid crystal cell, first, a mesogenic layer composed of an ultraviolet ray absorber, a photopolymerization initiator, and a polymerizable liquid crystalline monomer is formed on the substrate main face capable of transmitting ultraviolet ray. Next, the substrate is kept at given temperature at which the polymerizable liquid crystalline monomer is kept in a state of liquid crystal. While a magnetic field in a desired direction is applied, the mesogenic layer is irradiated with ultraviolet ray through the substrate, and thereby the polymerizable liquid crystalline monomer is polymerized to form a polymer layer. Next, unreacted substances on the surface are removed by washing with an organic solvent to leave only the polymer layer and thereby an alignment film is obtained. After that, a pair of substrates is arranged so that the alignment films are opposed to each other, and bonded with each other with a desired gap in between. Liquid crystal fills in the gap, and thereby a liquid crystal cell is formed. It is described that the mesogenic layer may be a layer composed of low-molecular liquid crystal, an ultraviolet absorber, a photopolymerization initiator, and a polymerizable liquid crystalline monomer, and a magnetic field and an electric field may be used together.

Further, it is described that when the main face of the substrate was previously coated with a silane coupler layer or a polar organic resin layer, it was effective to form a uniform mesogenic layer thereon. Actually, in Japanese Patent No. 3572787, in all examples in which a pretilt angle is specifically shown, the main face of the substrate is coated with a silane coupler layer or a polar organic resin layer, and a mesogenic layer is formed thereon.

FIG. 17B is a schematic view showing a horizontal alignment film and sections in the vicinity thereof based on the following description that is described in Example 1 of Japanese Patent No. 3572787. In Example 1, first, a silane coupler layer 115 composed of vinyltrimethoxy silane was formed on a main face of a low alkali glass substrate 102a (or 102b) provided with an ITO transparent electrode. After that, the surface thereof was coated with an acetone solution in which a small amount of benzophenone photopolymerization initiator was added to a polymerizable liquid crystalline monomer 116 such as 4-acryloyloxy-4′-butyl-bicyclohexyl. After that, the resultant was air-dried to form a mesogenic layer. According to observation with a polarization microscope, the mesogenic layer showed liquid crystal phase.

Next, a magnetic field was applied so that an angle made by a normal line of the substrate 102 and flux became about 65 degree (an angle made by a substrate face and flux became about 25 degree) to align the polymerizable liquid crystalline monomer 116. In this state, the mesogenic layer was irradiated with ultraviolet ray from the rear face side of the substrate 102 to polymerize at least part of the mesogenic layer, and thereby the polymer layer was formed. After that, the polymer layer was dipped into acetone for several minutes, unreacted substances were removed to obtain a horizontal alignment film 117. It was confirmed that retardation existed in the horizontal alignment film 117.

After that, the pair of substrates was arranged so that the horizontal alignment films 117 were opposed to each other and so that the direction of the magnetic field applied in forming the horizontal alignment film 117 became antiparallel, and was bonded together with a certain gap (10 μm) in between. Nematic liquid crystal ZLI-2293, Merck Ltd. make filled in the gap to form a liquid crystal cell. The pretilt angle in the liquid crystal cell was in the range from 23.2 to 23.5 degree.

In Japanese Patent No. 3572787, in addition, an example in which a horizontal alignment film was obtained is described. In the example, when an angle made by the substrate face and flux was 5 degree, 10 degree, and 15 degree, the horizontal alignment film expressed pretilt angles of 4.9 to 5.1 degree, 9.4 to 9.7 degree, and 13.6 to 13.8 degree.

Meanwhile, FIGS. 18A and 18B are cross sectional views showing an alignment technology used in VA mode. FIG. 18A shows an alignment state of homeotropic-aligned liquid crystal molecules 120 when an electric field is not applied. In VA mode, as the liquid crystal molecules 120 composing the liquid crystal layer 101, liquid crystal molecules having characteristics being aligned vertically to an interface with a dissimilar material are selected. As a result, when an electric field is not applied, the liquid crystal molecules 120 are able to be aligned vertically to a substrate face (homeotropic alignment state).

Further, as the liquid crystal molecules 120, molecules with negative dielectric constant anisotropy having characteristics that the long axis of the molecule is aligned approximately vertically to the electric field direction when an electric field is applied is selected and used. As a result, as shown in FIG. 18B, when an electric field is applied, the alignment direction of the liquid crystal molecules 120 is able to be changed close to a state that the long axis of the liquid crystal molecules 120 is aligned approximately vertically to the electric field direction (state that the long axis of the liquid crystal molecules 120 is aligned in parallel with the substrate face).

Further, in VA mode, two pieces of polarization plates 106a and 106b (refer to FIG. 16) are arranged in a cross nicol fashion so that each polarizing axis is perpendicular to each other. Thereby, the liquid crystal display device is able to be operated as a normally black liquid crystal display device in which when an electric field is not applied and the display-use liquid crystal molecules 120 are aligned vertically to the substrate face, almost no light is transmitted as shown in FIG. 18A; and when an electric field is applied and the display-use liquid crystal molecules 120 are aligned tilted from the normal line direction of a substrate face, light is transmitted as shown in FIG. 18B.

In VA mode, in the time of light blocking when an electric field is not applied, the liquid crystal molecules are aligned vertically to the substrate face. Thus, the light transmission factor in the time of light blocking becomes the minimum value determined by orthogonal nature of the polarization plates 106a and 106b. Therefore, compared to other operation modes, black close to real black darkness is able to be realized, and high contrast is obtained.

However, as shown in FIG. 18B, in the case of single domain VA mode in which all liquid crystal molecules belonging to the same pixel are tilted in the same direction, there are problems that tone reversal phenomenon is generated, for example, a direction in which light is not transmitted is generated in the time of applying an electric field when light should be transmitted, and accordingly view angle dependence is excessively increased. As a measure against such an issue, MVA (Multi-domain VA) mode, PVA (Patterned VA) mode (also known as EVA (Electrically tilted VA) mode) and the like are proposed.

FIGS. 19A and 19B are partial cross sectional views showing an alignment technology used in MVA mode. FIG. 19A shows an alignment state of liquid crystal molecules when an electric field is not applied. FIG. 19B shows an alignment state of the liquid crystal molecules 120 when an electric field is applied. In MVA mode, a small transparent protrusion 130 is provided in the center of a pixel by using photoresist technology. Therefore, when an electric field is not applied, major part of the liquid crystal molecules 120 in one pixel is aligned vertically to a substrate face. Meanwhile, liquid crystal molecules 131 surrounded with dotted lines in the figure that are located in the vicinity of the protrusion 130 are aligned in a direction slightly tilted to the right or the left from the direction perpendicular to the substrate face. Thereby, when an electric field is applied, alignment of the other liquid crystal molecules 120 is changed in a domino fashion, which is spread from the liquid crystal molecules 131 that are contacted with the protrusion 130 and are previously tilted as the origin point. As a result, one pixel is automatically divided into even numbers of domains in which each tilt direction of the liquid crystal molecules is opposite to each other based on the protrusion 130 as a boundary. FIGS. 19A and 19B show an example that two domains are formed right and left. However, in general, one pixel is divided right and left and back and forth centering on the protrusion 130, and accordingly four domains are formed.

As shown in FIG. 19B, in MVA mode, even if a liquid crystal screen is viewed from an oblique direction, light passing the liquid crystal molecules in which each tilt direction is opposite to each other reaches the screen from the plurality of domains in one pixel. Therefore, angle dependence is averaged, and view angle dependence is kept small.

FIGS. 20A and 20B are cross sectional views showing an alignment technology used in PVA mode. FIG. 20A shows an alignment state of liquid crystal molecules immediately after an electric field starts to be applied. FIG. 20B shows an alignment state of the liquid crystal molecules 120 when sufficient time lapses and alignment is completed after applying an electric field. In PVA mode, a slit 141 is provided in a transparent electrode 140, an electric field (fringe electric field) in an oblique direction is applied to partial liquid crystal molecules, and thereby the tilt direction of the liquid crystal molecules 120 is controlled. In this case, when an electric field is applied, first, liquid crystal molecules 142 receiving electric field (fringe electric field) in an oblique direction surrounded with dotted lines in FIG. 20A are tilted leftward or rightward according to the electric field direction. Next, alignment of the other liquid crystal molecules is changed in a domino fashion, which is spread from the former liquid crystal molecules as the origin point. As a result, as shown in FIG. 20B, one pixel is automatically divided into even numbers of domains in which each tilt direction of the liquid crystal molecules is opposite to each other based on the slit 141 as the boundary.

In PVA mode, in the same manner as that of MVA mode, even if a liquid crystal screen is viewed from an oblique direction, light passing the liquid crystal molecules in which each tilt direction is opposite to each other reaches the screen from the plurality of domains in one pixel. Therefore, angle dependence is averaged, and view angle dependence is kept small.

In the liquid crystal display device in MVA mode, in the time of light blocking when an electric field is not applied, the partial liquid crystal molecules 131 are not aligned vertically to the substrate face. Thus, light anisotropy is generated in the liquid crystal layer, and the light transmission factor in the time of light blocking becomes slightly larger than the minimum value determined by orthogonal nature of the polarization plates 106a and 106b. Therefore, compared to the liquid crystal display device in VA mode shown in FIGS. 18A and 18B, the contrast may be slightly lowered. Meanwhile, in the liquid crystal display device in PVA mode, the all liquid crystal molecules 120 are aligned vertically to the substrate face in the time of light blocking. Therefore, black close to real black darkness is able to be realized, and high contrast is obtained.

As described above, in VA mode including MVA mode and PVA mode, the alignment film 104 is not essential. However, in some cases, a vertical alignment film is formed as a support for vertical alignment of the liquid crystal molecules 120. In the foregoing horizontal alignment film, the liquid crystal molecules are aligned to be almost in parallel with the alignment film. Meanwhile, in the vertical alignment film, the liquid crystal molecules are aligned vertically to the alignment film. Therefore, the vertical alignment film necessitates the surface physicality and the surface structure that are totally different from those of the horizontal alignment film. Therefore, as a material of the vertical alignment film, for example, vertical alignment type polyimide or a silane coupling agent vertical alignment material is used, and rubbing treatment is not generally provided. Accordingly, though being called “alignment film” generically, the horizontal alignment film and the vertical alignment film are totally different in purposes and methods of realizing the purposes. Thus, the horizontal alignment film and the vertical alignment film should be regarded as a film different from each other.

In the simple VA mode shown in FIGS. 18A and 18B, the protrusion 130 or the slit 140 that regulates the tilt direction of the liquid crystal molecules 120 when the electric field is applied does not exist. In this case, any tilt direction of the liquid crystal molecules 120 from the normal line direction of the substrate face is equivalent. Therefore, when an electric field is applied, the tilt direction of the liquid crystal molecules 120 tends to be irregular. To prevent such an issue, as the pretilt is expressed by the horizontal alignment film, it is desirable that the liquid crystal molecules 120 are regulated so that the long axis direction of the liquid crystal molecules 120 is slightly tilted in a given direction from the normal line direction of the substrate face by a vertical alignment film when the electric field is not applied.

In MVA mode and PVA mode, as described above, when an electric field is applied, the tilt direction of the liquid crystal molecules 120 is not irregular. However, in MVA mode, alignment of the other liquid crystal molecules is changed in a domino fashion, which is spread from the liquid crystal molecules 131 previously tilted that are located in the vicinity of the protrusion 130 as the origin point. Therefore, compared to a case that alignment of all liquid crystal molecules is concurrently changed, the response speed is slower. Further, in PVA mode, alignment of the other liquid crystal molecules is changed in a domino fashion, which is spread from the liquid crystal molecules 142 that are firstly tilted by the electric field (fringe electric field) in an oblique direction as the origin point. Therefore, compared to the case that alignment of all liquid crystal molecules is concurrently changed, the response speed is slower. In PVA mode, further, there is an issue that a region not contributing to display is generated in a region in which an electric field is able to be applied to the liquid crystal layer 101 only vertically. Therefore, in these operation modes, it is also desirable to regulate the liquid crystal molecules 120 so that the long axis direction of the liquid crystal molecules 120 is slightly tilted in a given direction from the normal line direction of the substrate face by a vertical alignment film when an electric field is not applied.

As one of methods to slightly tilt the alignment direction of the liquid crystal molecules 120 from the normal line direction of the substrate face when an electric field is not applied, a method to process the surface of the vertical alignment film by rubbing treatment may be provided. However, such a method easily causes unevenness, and it is difficult to realize uniform tilts with the use of such a method. Accordingly, such a method has not been used.

As another method, a method of manufacturing a vertical alignment film using a photo-alignment material has been proposed. The photo-alignment material is a material that generates anisotropic liquid crystal alignment ability if being radiated with light in an oblique direction. In such a method, after the vertical alignment film is formed by using the vertical alignment material having photo-alignment characteristics, the vertical alignment film is irradiated with light in an oblique direction, and thereby the anisotropic liquid crystal alignment ability is expressed. For example, in the following Japanese Unexamined Patent Application Publication No. 2001-242465 (pp. 7-8, Examples 6, 4, and 1, and FIG. 1), a method of forming a vertical alignment polyimide film and irradiating the film with light twice in different irradiation directions is proposed, and an example in which the pretilt angle of a formed vertical alignment liquid crystal cell is 88 degree (tilt from the normal line direction of the substrate face is 2 degree) is reported.

Though different from the method of processing the vertical alignment film, in the following Japanese Unexamined Patent Application Publication No. 2002-357830 (pp. 9-10 and FIG. 1), a liquid crystal display unit in MVA mode in which the alignment direction of liquid crystal molecules when an electric field is not applied is slightly tilted from the normal line direction of the substrate face by forming a polymer hardened material aligned in a certain direction in the liquid crystal layer is proposed. The polymer hardened material is formed as follows. A small amount of light hardened liquid crystalline monomer is mixed in a liquid crystal layer. After a liquid crystal cell is assembled, a voltage is applied to the liquid crystal layer, and liquid crystal molecules and the liquid crystalline monomer are aligned. In this state, the liquid crystal layer is irradiated with ultraviolet light. The polymer hardened material desirably includes a liquid crystalline framework to effectively control the alignment of the liquid crystal molecules.

As described above, except for the rubbing treatment, as a method of aligning the liquid crystal molecules in a direction slightly tilted from the normal line direction of the substrate face, the structure using the vertical alignment film made of a light-alignment material is proposed in Japanese Unexamined Patent Application Publication No. 2001-242465 and the like. Further, the structure in which the polymer hardened material to align the liquid crystal molecules is provided in the liquid crystal layer is proposed in Japanese Unexamined Patent Application Publication No. 2002-357830.

However, in the structure using the photo-alignment material, it is insufficient as regarding long-time driving and thermal reliability. Further, in the structure providing the alignment-use structure in the liquid crystal layer such as Japanese Unexamined Patent Application Publication No. 2002-357830, there is concern that the voltage retention ratio is lowered due to mixing ionic impurities into the liquid crystal layer, operation characteristics and optical characteristics of the liquid crystal display device are impaired by the alignment-use structure.

In Japanese Unexamined Patent Application Publication No. 2-43517 and Japanese Patent No. 3572787, the methods of manufacturing the alignment film made of the aligned liquid crystalline material are proposed. However, these methods are the methods of manufacturing the horizontal alignment film having a pretilt angle of about 10 degree, for example, and not a method of manufacturing a vertical alignment film. For example, it is not impossible to form a vertical alignment film having a pretilt angle close to 90 degree only by simply changing the directions of an applied magnetic field and an applied electric field while the component material of the horizontal alignment film and the method of manufacturing it proposed in Japanese Patent No. 3572787 are not changed.

### SUMMARY

In view of the foregoing, it is an object of the present disclosure to provide a highly reliable vertical alignment film for aligning display-use liquid crystal molecules in a direction slightly tilted from the normal line direction of the substrate face and a method of manufacturing the vertical alignment film, a vertical alignment substrate including the vertical alignment film and a method of manufacturing the vertical alignment substrate, and a liquid crystal display device.

That is, in an embodiment a vertical alignment film is provided to be contacted with a display-use liquid crystal molecule layer for at least one of substrates in a liquid crystal display device having the display-use liquid crystal molecule layer and the substrates arranged with the display-use liquid crystal molecule layer in between, and that controls an alignment direction of display-use liquid crystal molecules in the display-use liquid crystal molecule layer approximately vertically to a substrate face of the substrate. The vertical alignment film is formed from a layer composed of polymerizable liquid crystal molecules that have a crystalline framework, and have characteristics to align a director (alignment vector) vertically to an interface with a dissimilar material and polymerizable characteristics. At least part of the polymerizable liquid crystal molecules is polymerized in the case where the layer composed of the polymerizable liquid crystal molecules is in a state of liquid crystal and in a state that the director is aligned in a direction slightly tilted from a normal line direction of the substrate face, the layer composed of the polymerizable liquid crystal molecules is changed into a layer formed from a complex composed of the unreacted polymerizable liquid crystal molecules and a polymerizable liquid crystal molecule polymer and hardened, and thereby the vertical alignment film is formed. The alignment direction of the director in the complex is fixed in the direction slightly tilted from the normal line direction of the substrate face.

It is enough that the polymerizable liquid crystal molecules are polymerized to the degree that the complex is hardened and the alignment direction of the liquid crystalline framework in the complex is surely fixed. The foregoing description, “at least part of the polymerizable liquid crystal molecules is polymerized” means that the unreacted polymerizable liquid crystal molecules in some degree may be left in the complex if such a condition is satisfied. It is not necessary to totally eliminate the unreacted polymerizable liquid crystal molecules, and in actuality, it is not possible to totally eliminate the unreacted polymerizable liquid crystal molecules. Further, it is often the case that the polymerizable liquid crystal molecules are a polymerizable monomer, but may be an oligomer such as a dimer.

Further, in an embodiment a method of forming a vertical alignment film that is provided to be contacted with a display-use liquid crystal molecule layer for at least one of substrates in a liquid crystal display device having the display-use liquid crystal molecule layer and the substrates arranged with the display-use liquid crystal molecule layer in between, and that controls an alignment direction of display-use liquid crystal molecules in the display-use liquid crystal molecule layer approximately vertically to a substrate face of the substrate is provided. The method includes: forming a layer composed of polymerizable liquid crystal molecules that have a crystalline framework, and have characteristics to align a director (alignment vector) vertically to an interface with a dissimilar material and polymerizable characteristics for the substrate; aligning the director in a direction slightly tilted from a normal line direction of the substrate face while keeping the layer composed of the polymerizable liquid crystal molecules in a state of liquid crystal; and polymerizing at least part of the polymerizable liquid crystal molecules in the foregoing state that the director is aligned, changing the layer composed of the polymerizable liquid crystal molecules into a layer formed from a complex composed of the unreacted polymerizable liquid crystal molecules and a polymerizable liquid crystal molecule polymer and hardening the layer. As the vertical alignment film, the layer composed of the complex in which the alignment direction of the director is fixed in the direction slightly tilted from the normal line direction of the substrate face is formed.

Further, in an embodiment a vertical alignment substrate is provided and is arranged to be contacted with a display-use liquid crystal molecule layer of a liquid crystal display device, characterized in that the vertical alignment film is provided on a face side contacted with the display-use liquid crystal molecule layer. Further, an embodiment relates to a method of manufacturing a vertical alignment substrate arranged to be contacted with a display-use liquid crystal molecule layer of a liquid crystal display device, characterized in that a step of forming a vertical alignment film on a face side contacted with the display-use liquid crystal molecule layer by the method of forming a vertical alignment film is included.

Further, in an embodiment a liquid crystal display device includes: a display-use liquid crystal molecule layer; and substrates arranged oppositely with the display-use liquid crystal molecule layer in between, characterized in that the vertical alignment film is provided for at least one of the substrates so that the vertical alignment film is contacted with the display-use liquid crystal molecule layer. An alignment direction of the display-use liquid crystal molecules when an electric field is not applied is controlled in a direction slightly tilted from a normal line direction of the substrate face.

The vertical alignment film of the embodiment is characterized in that at least part of the polymerizable liquid crystal molecules is polymerized, the layer composed of the polymerizable liquid crystal molecules is changed into the layer formed from the complex composed of the unreacted polymerizable liquid crystal molecules and the polymerizable liquid crystal molecule polymer and hardened, and thereby the vertical alignment film is formed, and that the alignment direction of the director in the complex forming the vertical alignment film is fixed in the direction slightly tilted from the normal line direction of the substrate face. The polymerizable liquid crystal molecules and the polymer in the complex having the liquid crystalline framework aligned as above align the long axis of the display-use liquid crystal molecules arranged contacted therewith in a direction slightly tilted from the normal line direction of the substrate face by interaction between the liquid crystal molecules.

In an embodiment, the method of forming a vertical alignment film includes: forming the layer composed of the polymerizable liquid crystal molecules that have the crystalline framework, and have the characteristics to align the director (alignment vector) vertically to the interface with a dissimilar material and the polymerizable characteristics for the substrate; and aligning the director in the direction slightly tilted from the normal line direction of the substrate face while keeping the layer composed of the polymerizable liquid crystal molecules in the state of liquid crystal. As the polymerizable liquid crystal molecules, the molecules that have the characteristics to align the director vertically to the interface with a dissimilar material are used. Therefore, in the layer composed of the polymerizable liquid crystal molecules, the step of aligning the director in the direction slightly tilted from the normal line direction of the substrate face is able to be easily performed by using an action of a magnetic field or the like.

Further, as a material forming the vertical alignment film, the polymerizable liquid crystal molecules that have the polymerizable characteristics are used. Therefore, by the step of polymerizing at least part of the polymerizable liquid crystal molecules in the foregoing state that the director is aligned, changing the layer composed of the polymerizable liquid crystal molecules into the layer formed from the complex composed of the unreacted polymerizable liquid crystal molecules and the polymerizable liquid crystal molecule polymer and hardening the layer, the alignment of the director is able to be fixed.

Accordingly, the vertical alignment film in which alignment of the director is well ordered is able to be surely formed.

Further, in the vertical alignment substrate of the embodiment, the vertical alignment film is provided on the face side contacted with the display-use liquid crystal molecule layer. Therefore, the vertical alignment substrate functions as a substrate to express the function of the vertical alignment film. Further, the method of manufacturing a vertical alignment substrate includes the step of forming the vertical alignment film on the face side contacted with the display-use liquid crystal molecule layer by the method of forming a vertical alignment film. Therefore, the vertical alignment film in which alignment of the director is well ordered is able to be surely formed.

In the liquid crystal display device, the vertical alignment film is provided to be contacted with the display-use liquid crystal molecule layer for at least one of the substrates, and the alignment direction of the display-use liquid crystal molecules when an electric field is not applied is controlled in the direction slightly tilted from the normal line direction of the substrate face. Therefore, when an electric field is applied, the tilt direction of the display-use liquid crystal molecules is not irregular, and favorable operation characteristics and favorable optical characteristics as a liquid crystal display device are able to be realized. Furthermore, the alignment of the all display-use liquid crystal molecules are concurrently changed. Thus, compared to the liquid crystal display device in MVA mode or in PVA mode in which alignment of the other liquid crystal molecules is changed in a domino fashion, which is spread from partial liquid crystal molecules as the origin point, faster response speed is able to be realized.

In the vertical alignment film, it is preferable that the layer composed of the polymerizable liquid crystal molecules is a layer that has been once in a state of liquid crystal in which the director is aligned vertically to the substrate face and then has changed to the state in which the director is aligned in the direction slightly tilted from the normal line direction of the substrate face. In this case, since the polymerizable liquid crystal molecules are the molecules having characteristics to align the director vertically to an interface, the polymerizable liquid crystal molecules comparatively easily come into a state of liquid crystal in which the director is aligned vertically to the substrate face, and each alignment direction of each polymerizable liquid crystal molecule is easily ordered. In the case where only the orientation of the director of this layer is slightly changed when characteristics of the polymerizable liquid crystal molecules to regulate respective alignment directions by interaction between the liquid crystal molecules and to cooperatively behave are expressed, the previous state is changed to the state in which the director is aligned in the direction slightly tilted from the normal line direction of the substrate face. Therefore, a layer in which the alignment direction of each polymerizable liquid crystal molecule in the layer is uniformly ordered in a given direction is formed.

Further, the alignment direction of the director in the complex is preferably in a direction tilted by 0.1 to 20 degree from the normal line direction of the substrate face. The alignment direction of the director in the complex is desirably in a direction tilted by 1 to 10 degree from the normal line direction, and more desirably tilted by 1 to 5. In the case where the alignment direction is excessively small, the function to incline the display-use liquid crystal molecules is hardly expressed. Meanwhile, in case where the alignment direction is excessively large, in-plane retardation tends to become large, and front face contrast tends to be lowered. In this case, the alignment direction of the director represents the average alignment direction in the long axis direction of the liquid crystalline framework, and is able to be obtained from, for example, tilt angle (incident angle) dependence of retardation. Then, it is necessary to consider that in the case where light diagonally enters the liquid crystal layer from the air, an angle of light actually passing the liquid crystal layer is smaller than the incidence angle of the light entering the interface with the liquid crystal layer from the air due to refraction of light at the interface.

In this case, the alignment direction of the liquid crystal display device when an electric field is not applied is able to be controlled in a direction tilted by 0.1 to 5 degree from the normal line direction of the substrate face. The alignment direction is desirably a direction tilted by 0.5 to 2.5 degree from the normal line direction, and more preferably a direction tilted by 0.8 to 1.5 degree from the normal line direction. The tilt angle of the display-use liquid crystal molecules is able to be examined by, for example, crystal rotation method. In the case that where the tilt in the alignment direction of the liquid crystal display device is excessively small, effect to determine the regular tilt direction of the display-use liquid crystal molecules when an electric field is applied, and effect to realize fast response speed by concurrent alignment change of the all display-use liquid crystal molecules are not obtained. Meanwhile, in the case where the tilt in the alignment direction of the liquid crystal display device is excessively large, in-plane retardation is generated by optical anisotropy of the aligned liquid crystal display device, light transmission factor in the time of blocking becomes excessively large, and front face contrast is lowered down to an unacceptable level.

Further, the polymerizable liquid crystal molecules preferably have at least one functional group selected from the group consisting of an acryloyloxy group, a methacryloyloxy group, a vinyl ether group, and an epoxy group as a polymerizable functional group. These functional groups are able to be polymerized by irradiation of ultraviolet ray, infrared ray, or electron ray, and/or heating. To make the polymerizable liquid crystal molecules come into the alignment state slightly tilted from the normal line direction of the substrate face, it is preferable that firstly the polymerizable liquid crystal molecules are aligned almost totally perpendicular to the substrate face, and then the alignment direction is slightly tilted. To align the polymerizable liquid crystal molecules vertically to the substrate face, the polymerizable functional group is preferably the acryloyloxy group or the methacryloyloxy group.

Further, the polymerizable liquid crystal molecules are preferably molecules having large magnetic susceptibility anisotropy. In this case, in the case where the liquid crystalline framework of the polymerizable liquid crystal molecules is aligned by a magnetic field, the magnetic field effectively acts on the polymerizable liquid crystal molecules. Diamagnetism shown by molecules are largely expressed, for example, in the case where local existence of n electron such as a benzene ring is released and a circular current is formed qualitatively. Therefore, the polymerizable liquid crystal molecules are preferably a molecule having an aromatic ring. The larger number of aromatic rings in the molecule is preferable, since thereby anisotropy of the diamagnetic susceptibility becomes larger.

Then, to align the polymerizable liquid crystal molecules by a magnetic field, the polymerizable liquid crystal molecules are preferably a bar-like molecule. The reason thereof is as follows. In the benzene ring exposed in the magnetic field, when the plane of the benzene ring is perpendicular to the direction of the magnetic field, energy becomes highest, and when the plane of the benzene ring is in parallel with the direction of the magnetic field, energy becomes lowest. Therefore, the polymerizable liquid crystal molecules in the magnetic field are aligned so that the benzene ring in the molecules is in parallel with the magnetic field. In the case where the polymerizable liquid crystal molecules are the bar-like molecule, the orientation of the director corresponds with the direction of the molecular framework including the benzene ring, and thus the director is aligned in the direction of the magnetic field. As a result, the direction of the director is able to be determined only by application of the magnetic field. Meanwhile, in the case where the polymerizable liquid crystal molecules are a disk-like molecule, the direction of the director is perpendicular to the plane of the molecule framework including the benzene ring. Therefore, the director is aligned perpendicular to the direction of the magnetic field. As a result, the direction of the director is not determined uniquely only by the application of the magnetic field. To determine the direction of the director, it is necessary to use another method in addition to the magnetic field.

Further, in each pixel, the layer composed of the complex is preferably formed as a pattern composed of a plurality of regions in which the tilt direction of the director is different from each other. In this case, the pixel is formed in a multidomain fashion, and view angle dependence of the liquid crystal display device is able to be kept small.

The display-use liquid crystal molecules are preferably aligned in a direction tilted by 0.1 to 5 degree from the normal line direction of the substrate face, desirably in a direction tilted by 0.5 to 2.5 degree from the normal line direction of the substrate face, and more desirably in a direction tilted by 0.8 to 1.5 degree from the normal line direction of the substrate face. The reason thereof is as described above.

Further, the display-use liquid crystal molecules are preferably aligned tilted in the opposite direction of the alignment direction of the director in relation to the normal line direction of the substrate face. Such an example was observed in an example. In this case, tone change due to change of the vie angle is inhibited, and effect to resolve view angle dependence is obtained.

Mechanism that the tilt direction of the director is opposite to the tilt direction of the display-use liquid crystal molecules is currently unknown. Alignment of the director in a bulk of the layer composed of the polymerizable liquid crystal molecules when a magnetic field is applied is understood by so-called continuous elastic body theory. In this case, in the central section in the film thickness direction of the layer composed of the polymerizable liquid crystal molecules, the liquid crystalline framework is aligned in the magnetic direction most. The alignment direction of the director in the bulk is able to be measured by measuring tilt angle dependence of retardation or the like.

Meanwhile, it is the liquid crystalline framework located on the surface of the layer composed of the complex, that is, the liquid crystalline framework of the polymerizable liquid crystal molecules that have occupied the surface of the layer composed of the polymerizable liquid crystal molecules to directly control the alignment of the display-use liquid crystal molecules. The crystalline framework is contacted with air such as nitrogen atmosphere, and it is not always depict it by the totally same elastic body theory as that of the bulk. For example, in a free interface, according to the relation of surface energy, a specific group in the polymerizable liquid crystal molecules is possibly arranged toward the free interface. Further, it is conceived that in the interface between the layer composed of the polymerizable liquid crystal molecules and an air layer, the density is continuously changed, which may be regarded as a state changing from a liquid crystal phase to an isotropic phase. Accordingly, the polymerizable liquid crystal molecules on the surface are aligned in a direction different from the direction of the polymerizable liquid crystal molecules in the bulk. As a result, it is possible that the display-use liquid crystal molecules are aligned tilted in the opposite direction of the direction in which the director is aligned (in the bulk) in relation to the normal line direction of the substrate.

In the method of forming a vertical alignment film, it is preferable that before the step of aligning the director, a treatment to make the polymerizable liquid crystal molecules come into a state of liquid crystal in which the director is aligned vertically to the substrate face in the layer composed of the polymerizable liquid crystal molecules is performed. The polymerizable liquid crystal molecules are the molecule having the characteristics to align the director vertically to an interface. Therefore, it is comparatively easy to make the polymerizable liquid crystal molecules come into the state of liquid crystal in which the director is aligned vertically to the substrate face. In the case where the orientation of the director of this layer is changed, change portion in the alignment direction of the director may be small. Further, characteristics that the polymerizable liquid crystal molecule regulates each alignment direction by interaction between the liquid crystal molecules and behaves cooperatively are able to be used. Therefore, each polymerizable liquid crystal molecule in the layer is able to be aligned in a given direction uniformly and orderly.

Then, after the step of forming the layer composed of the polymerizable liquid crystal molecules and before the step of aligning the director, a step of increasing temperature of the layer composed of the polymerizable liquid crystal molecules, once making the polymerizable liquid crystal molecules come into a state of isotropic phase, and then gradually lowering the temperature of the layer composed of the polymerizable liquid crystal molecules, and thereby making the polymerizable liquid crystal molecules come into a state of liquid crystal in which the director is aligned vertically to the substrate face is preferably performed. In the case where once the polymerizable liquid crystal molecules come into the state of isotropic phase as described above, a state of the initial layer composed of the polymerizable liquid crystal molecules divided into many small regions in which though the alignment direction of the polymerizable liquid crystal molecules is ordered in every small region, each alignment direction of the polymerizable liquid crystal molecules varies according to each small region, and a state in which a defect such as disclination exists are resolved, and then the layer composed of the polymerizable liquid crystal molecules is gradually cooled during a sufficient time to align the polymerizable liquid crystal molecules in an optimal state, and thereby a layer in which alignment of almost all polymerizable liquid crystal molecules is ordered in one direction perpendicular to the interface is able to be formed.

Further, the director in the layer composed of the polymerizable liquid crystal molecules is preferably aligned in a direction tilted by 0.1 to 20 degree from the normal line direction of the substrate face, desirably in a direction tilted by 1 to 10 degree from the normal line direction of the substrate face, and more desirably in a direction tilted by 1 to 5 degree from the normal line direction of the substrate face by the magnetic field. The reason thereof is as described above.

Further, the polymerizable liquid crystal molecules are preferably polymerized by irradiation of ultraviolet ray, infrared ray, or electron ray, and/or heating. As a method of polymerizing the polymerizable liquid crystal molecules, these methods are cited, but the method is not particularly limited thereto. However, radiation of ultraviolet ray is most preferable, since therewith various polymerizable liquid crystal molecules are able to be applied and it is easy to implement it. In this case, as described above, as the polymerizable liquid crystal molecules, molecules having at least one functional group selected from the group consisting of an acryloyloxy group, a methacryloyloxy group, a vinyl ether group, and an epoxy group as a polymerizable functional group is preferably used.

Further, the director is preferably aligned in the direction slightly tilted from the normal line direction of the substrate face by applying a magnetic field to the layer composed of the polymerizable liquid crystal molecules kept in the state of liquid crystal. In this case, as described above, as the polymerizable liquid crystal molecules, molecules having large magnetic susceptibility anisotropy such as molecules having an aromatic ring are preferably used. However, the method is not limited to the foregoing method, but for example, the director may be aligned by an electric field.

Further, it is preferable to perform a step of polymerizing the polymerizable liquid crystal molecules in partial regions in each pixel by radiation of ultraviolet ray, infrared ray, or electron ray with the use of a photo mask is performed for every plurality of regions in a pixel while changing an application direction of a magnetic field, and thereby in each pixel, the layer composed of the complex is preferably formed as a pattern composed of a plurality of regions in which a tilt direction of the crystalline framework is different from each other. In this case, the pixel is easily and surely changed into a state of multidomain, and thereby the view angle dependence of the liquid crystal display device is kept small.

In the liquid crystal display device, it is preferable that the vertical alignment films are provided for the both substrates, and each aligmnent direction of the crystalline framework in the respective films arranged oppositely is in parallel with each other in the two vertical alignment films. In this case, each alignment direction of each long axis of the display-use liquid crystal molecules controlled by the two vertical alignment films becomes in parallel with each other, and the display-use liquid crystal molecules are aligned uniformly tilted from the normal line direction of the substrate face. The vertical alignment film may be provided for only one of the substrates.

Further, the alignment direction of the display-use liquid crystal molecules when an electric field is not applied is preferably a direction tilted from the normal line direction of the substrate by 0.1 to 5 degree, desirably by 0.5 to 2.5 degree, and more desirably by 0.8 to 1.5 degree. The reason thereof is as described above.

Further, the alignment direction of the display-use liquid crystal molecules when an electric field is not applied is preferably the opposite direction of the alignment direction of the crystalline framework in the vertical alignment film in relation to the normal line direction of the substrate face.

Further, an optical compensated layer to eliminate optical anisotropy generated by the vertical alignment film and the display-use liquid crystal molecules when an electric field is not applied is preferably provided. The optical compensated layer is able to be formed from a negative C plate having the same alignment direction as that of the vertical alignment film. In this case, the foregoing optical anisotropy is eliminated, and thereby increase of the light transmission factor in the time of light blocking and contrast lowering due to the foregoing optical anisotropy are kept to a minimum.

Further, the liquid crystal display device may be structured as a transmissive liquid crystal display device that forms a transmissive liquid crystal display unit in combination with a backlighting unit.

Other and further objects, features and advantages will appear more fully from the following description.

Additional features and advantages are described herein, and will be apparent from the following Detailed Description and the figures.

### BRIEF DESCRIPTION OF THE FIGURES

FIGS. 1A and 1B are partial cross sectional views showing structures of a vertical alignment film and a liquid crystal display device according to a first embodiment;

FIGS. 2A to 2C are partial cross sectional views showing a flow of steps of forming the vertical alignment film, a vertical alignment substrate, and the liquid crystal display device according to the first embodiment;

FIGS. 3A and 3B are partial cross sectional views showing a flow of steps of forming the vertical alignment film, the vertical alignment substrate, and the liquid crystal display device according to the first embodiment;

FIG. 4 is a partial cross sectional view showing a structure of a liquid crystal display device based on a modified example of the first embodiment;

FIGS. 5A and 5B are partial cross sectional views showing structures of a vertical alignment film and a liquid crystal display device according to a second embodiment;

FIGS. 6A to 6C are partial cross sectional views showing a flow of steps of forming the vertical alignment film, a vertical alignment substrate, and the liquid crystal display device according to the second embodiment;

FIGS. 7A and 7B are partial cross sectional views showing a flow of steps of forming the vertical alignment film, the vertical alignment substrate, and the liquid crystal display device according to the second embodiment;

FIG. 8A is a graph showing a measurement result of retardation of a vertical alignment substrate of an example, FIG. 8B is an explanation diagram showing a measurement direction, and FIG. 8C is a cross sectional view of a liquid crystal cell;

FIG. 9A is a graph showing a measurement result of retardation of a vertical alignment substrate of a comparative example, FIG. 9B is an explanation diagram showing a measurement direction, and FIG. 9C is a cross sectional view of a liquid crystal cell;

FIGS. 10A and 10B are photographs showing change of an external appearance of the liquid crystal cells when a voltage applied to the liquid crystal cells of Example 1 and Comparative example 1 is turned on and off;

FIGS. 11A and 11B are observation images by a polarization microscope when a voltage is applied to the liquid crystal cells of Example 1 and Comparative example 1;

FIG. 12A is a graph showing a measurement result of retardation of the liquid crystal cell of the example, FIG. 12B is an explanation diagram showing a measurement direction, and FIG. 12C is a cross sectional view of the liquid crystal cell;

FIG. 13A is a graph showing a measurement result of retardation of the liquid crystal cell of the example, FIG. 13B is an explanation diagram showing a measurement direction, and FIG. 13C is a cross sectional view of the liquid crystal cell;

FIG. 14A is a graph showing a measurement result of retardation of the liquid crystal cell of the comparative example, FIG. 14B is an explanation diagram showing a measurement direction, and FIG. 14C is a cross sectional view of the liquid crystal cell;

FIGS. 15A and 15B are graphs showing a result of measuring retardation while applying a voltage for the liquid crystal cell of the example;

FIG. 16 is a partial cross sectional view showing a basic structure of an existing liquid crystal display device;

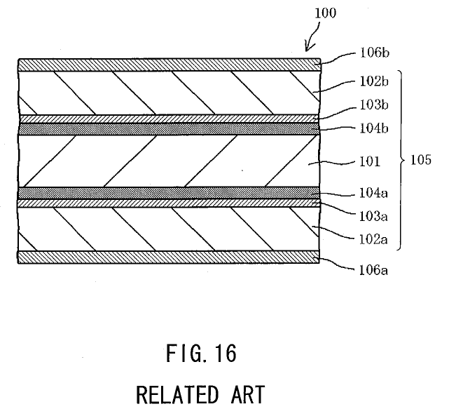

FIG. 17A is an explanation view showing an alignment technology used in TN mode, IPS mode, ECB mode, OCB mode and the like; and FIG. 17B is an explanation view showing an example of a horizontal alignment film;

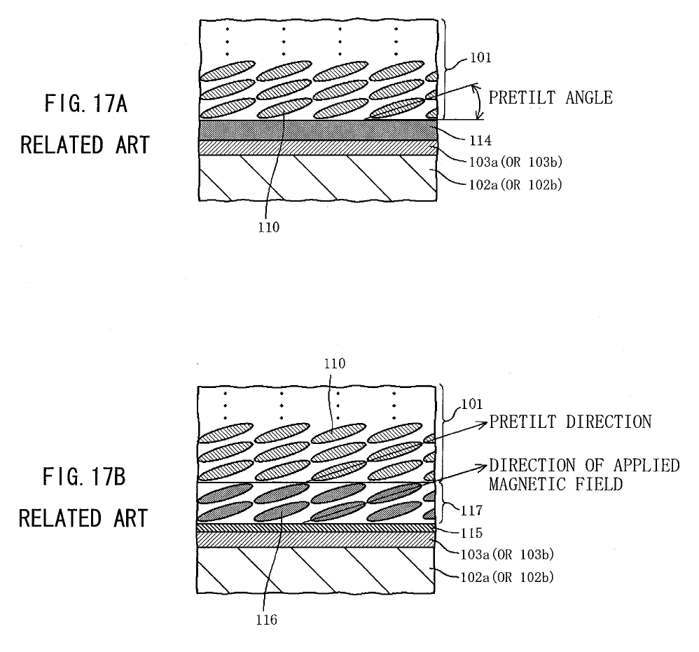

FIGS. 18A and 18B are partial cross sectional views showing an alignment technology used in VA mode;

FIGS. 19A and 19B are partial cross sectional views showing an alignment technology used in MVA mode; and

FIGS. 20A and 20B are partial cross sectional views showing an alignment technology used in PVA mode.

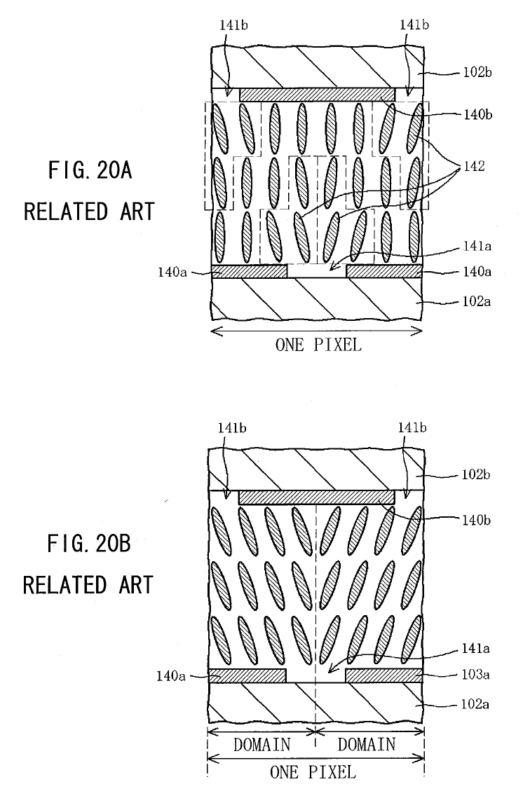

### DETAILED DESCRIPTION

Next, embodiments will be hereinafter described more specifically with reference to the drawings.

### First Embodiment

In the first embodiment, descriptions will be mainly given of an example of a vertical alignment film described in claims 1 to 8 and 13 and a method of manufacturing it described in claims 14 to 24, a vertical alignment substrate and a method of manufacturing it described in claims 26 and 27, and a liquid crystal display device described in claims 28 to 35.

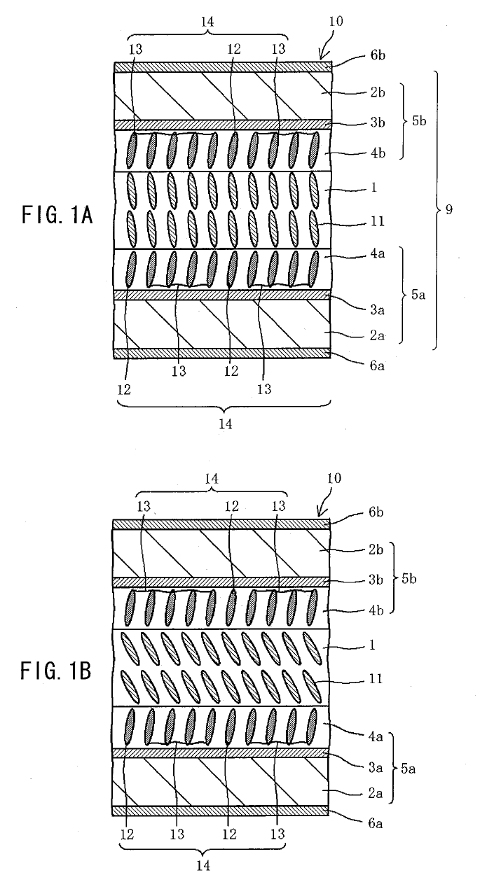

FIGS. 1A and 1B are partial cross sectional views showing structures of the vertical alignment film, the vertical alignment substrate, and the liquid crystal display device based on the first embodiment. A liquid crystal display device 10 is structured as a liquid crystal display device that operates in VA (Vertical Alignment) mode. FIG. 1A shows an alignment state of a display-use liquid crystal molecules 11 when an electric field is not applied.

In the liquid crystal display device 10, a liquid crystal cell 9 is formed from a liquid crystal layer 1 as the foregoing display-use liquid crystal molecule layer and a pair of transparent substrates 2a and 2b oppositely arranged with the liquid crystal layer 1 in between. On the outer face sides of the transparent substrates 2a and 2b, a pair of polarization plates 6a and 6b are respectively arranged. The transparent substrates 2a and 2b as the substrate are made of a glass substrate or the like. On the inner face side of the transparent substrate 2a, a transparent electrode 3a and a vertical alignment film 4a are formed. On the inner face side of the transparent substrate 2b, an (not-shown) color filter composed of three primary colors R (red), G (green), and B (blue), a transparent electrode 3b, and a vertical alignment film 4b are formed. The transparent electrodes 3a and 3b are composed of, for example, ITO (Indium Tin Oxide) or the like. The transparent substrate 2a and the transparent substrate 2b respectively provided with the vertical alignment film 4a and the vertical alignment film 4b are a vertical alignment substrate 5a and a vertical alignment substrate 5b.

The display-use liquid crystal molecules 11 composing the liquid crystal layer 1 are molecules having characteristics to be aligned vertically to an interface with a dissimilar material. Therefore, when an electric field is not applied, as shown in FIG. 1A, the display-use liquid crystal molecules 11 are homeotropic-aligned almost vertically to a face of the transparent substrate 2 (hereinafter 2a and 2b are collectively referred to as 2, and the same is applied to the other members). However, the alignment direction of the display-use liquid crystal molecules 11 is not totally vertical to the face of the transparent substrate 2. The reason thereof is that the long axis of the display-use liquid crystal molecules 11 is controlled to be aligned in a direction slightly tilted from the normal line direction of the transparent substrate 2, for example, in the direction tilted by 0.1 to 5 degree, desirably by 0.5 to 2.5 degree, and more desirably by 0.8 to 1.5 degree by action of the vertical alignment film 4 based on the present application.

The vertical alignment film 4 is formed from, as a starting point, a layer composed of polymerizable liquid crystal molecules 12 that have a crystalline framework and that have characteristics to align the director (alignment vector) vertically to an interface with a dissimilar material and polymerizable characteristics. That is, in the layer composed of the polymerizable liquid crystal molecules 12 formed on the transparent substrate 2, at least part of the polymerizable liquid crystal molecules 12 composing the layer is polymerized in a state of liquid crystal and in a state that the director is slightly tilted from the normal line direction of the transparent substrate 2. Thereby, the layer composed of the polymerizable liquid crystal molecules 12 is changed into a layer formed from a complex 14 composed of the unreacted polymerizable liquid crystal molecules 12 and a polymerizable liquid crystal molecule polymer 13, and hardened.

As a result, the alignment direction of the director in the complex 14 composing the vertical alignment film 4 is fixed in a direction slightly tilted from the normal line direction of the transparent substrate 2, for example, in the direction tilted by 0.1 to 20 degree, desirably by 1 to 10 degree, and more desirably by 1 to 5 degree. Due to interaction between the liquid crystal molecules, the crystalline framework slightly tilted from the normal line direction of the transparent substrate 2 is able to align the long axis of the display-use liquid crystal molecules 11 in a direction slightly tilted from the normal line direction of the transparent substrate 2, for example, in the direction tilted by 0.1 to 5 degree, desirably by 0.5 to 2.5 degree, and more desirably by 0.8 to 1.5 degree. FIG. 1A shows an example that the liquid crystalline framework in the vertical alignment film 4 aligns the display-use liquid crystal molecules 11 in an opposite tilt direction of the tilt direction of the director in relation to the normal line direction of the transparent substrate 2.

FIG. 1A shows an example that the vertical alignment films 4a and 4b are respectively provided for both the transparent substrates 2a and 2b, and each alignment direction of the director in the two vertical alignment films 4a and 4b is in parallel with each other. In this case, each alignment direction of each long axis of the display-use liquid crystal molecules 11 controlled by the two vertical alignment films 4a and 4b becomes in parallel with each other, and the display-use liquid crystal molecules 11 are aligned uniformly tilted from the normal line direction of the main face of the transparent substrate 2. Though FIG. 1A shows an example that the vertical alignment film is provided for the both transparent substrates 2a and 2b, the vertical alignment film may be provide for only one of the transparent substrates 2a and 2b.

The polymerizable liquid crystal molecules 12 preferably have at least one functional group selected from the group consisting of an acryloyloxy group, a methacryloyloxy group, a vinyl ether group, and an epoxy group as a polymerizable functional group. These functional groups are able to be polymerized by irradiation of ultraviolet ray, infrared ray, or electron ray, and/or heating. Specially, a polymerizable functional group having characteristics being polymerized by irradiation of ultraviolet ray is preferable, since such a functional group is able to be easily polymerized by irradiation of ultraviolet ray. To keep the polymerizable liquid crystal molecules 12 in a state of alignment slightly tilted from the normal line direction of the substrate face of the transparent substrate 2, it is preferable that firstly the polymerizable liquid crystal molecules 12 are aligned almost totally vertically to the substrate face, and then the alignment direction is slightly tilted. To align the polymerizable liquid crystal molecules 12 vertically to the substrate face, the polymerizable functional group is preferably an acryloyloxy group or a methacryloyloxy group.

Further, as described before, the polymerizable liquid crystal molecules 12 are preferably molecules having large magnetic susceptibility anisotropy. Thereby, in the case where the crystalline framework of the polymerizable liquid crystal molecules 12 is aligned by a magnetic field, the magnetic field effectively acts on the polymerizable liquid crystal molecules 12. To this end, the polymerizable liquid crystal molecules 12 are preferably molecules having an aromatic ring. The larger number of aromatic rings in the molecule is preferable, since thereby anisotropy of dimagnetic susceptibility becomes large. The polymerizable liquid crystal molecules 12 are preferably bar-like molecules in order to control the orientation of the director by only the magnetic field.

Further, the polymerizable liquid crystal molecules 12 preferably have characteristics that the layer composed of the polymerizable liquid crystal molecules 12 is easily formed by providing coating method or the like. That is, it is necessary that the coating uniformity and the stability thereof on the transparent electrode 2 such as ITO are also considered. The stability herein means that cohesion and alignment change are hardly generated during the period from coating to the step of polymerizing the polymerizable liquid crystal molecules 12. Further, since it is essential that the polymerizable liquid crystal molecules 12 have a function to align the display-use liquid crystal molecules 11, it is preferable that an interfacial active agent and a polymerization inhibitor that are materials other than the polymerizable liquid crystal molecules 12 are not contained as much as possible.

According to the temperature range in which the liquid crystal state is kept, drying conditions of the solvent, and alignment treatment conditions, it is possible to mix several types of the polymerizable liquid crystal molecules 12 and adjust the liquid crystal temperature range as appropriate. Further, in view of ability to realize a nematic phase at room temperature, a monofunctional polymerizable liquid crystal molecules are able to be used preferably as the polymerizable liquid crystal molecules 12.

As molecules to satisfy the foregoing conditions, the polymerizable liquid crystal molecules 12 are, for example, preferably the liquid crystal molecules shown in the following formulas.

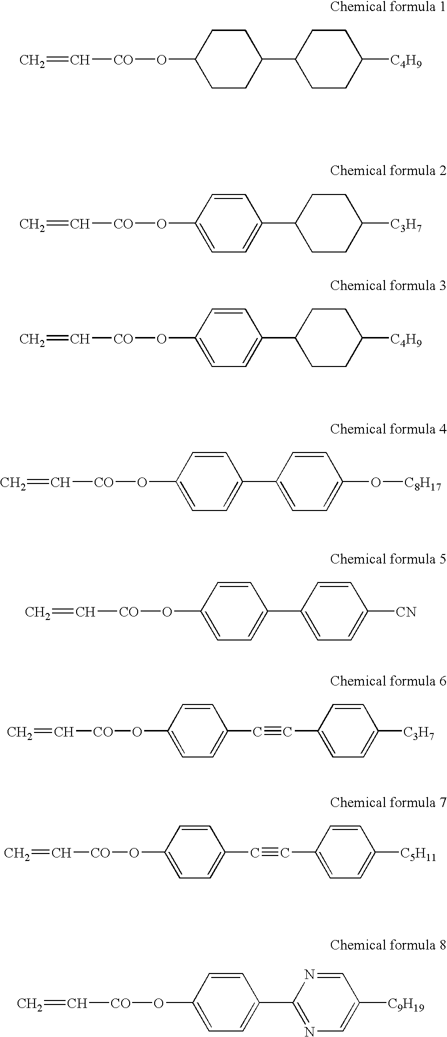

To enable the liquid crystal device 10 operate in VA mode, as the display-use liquid crystal molecules 11, molecules that have the negative dielectric constant anisotropy, and that have characteristics that the long axis of the molecules are aligned almost vertically to the electric field direction when an electric field is applied are used. Therefore, in the case where a voltage is applied between the transparent electrode 3a and the transparent electrode 3b and an electric field is applied to the display-use liquid crystal molecules 11, as shown in FIG. 1B, the display-use liquid crystal molecules 11 change the alignment direction close to a state that the long axis thereof is aligned approximately vertically to the electric field direction (state that the long axis is aligned in parallel with the substrate face).

As the display-use liquid crystal molecules 11, for example, the liquid crystal molecules shown in the following general formula I are able to be used (refer to Japanese Unexamined Patent Application Publication No 8-104869).

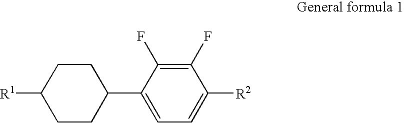

In the formula, R¹ and R² are respectively and independently H, or an unsubstituted alkyl group/an unsubstituted alkenyl group having carbon atoms up to 18 in number. One CH₂ group or two or more nonadjacent CH₂ groups existing in the group may be substituted with a group selected from the group consisting of —O—, —S—, and —C≡C—.

Further, the two piece of polarization plates 6a and 6b are arranged in a cross nicol state in which each polarizing axis is perpendicular to each other. Therefore, the liquid crystal display device 10 is operated as a normally black liquid crystal display device in which when an electric field is not applied and the display-use liquid crystal molecules 11 are aligned almost vertically to the face of the transparent substrate 2, almost no light is transmitted as shown in FIG. 1A; and when an electric field is applied and the display-use liquid crystal molecules 11 are aligned tilted from the normal line direction of a substrate, light is transmitted as shown in FIG. 1B.

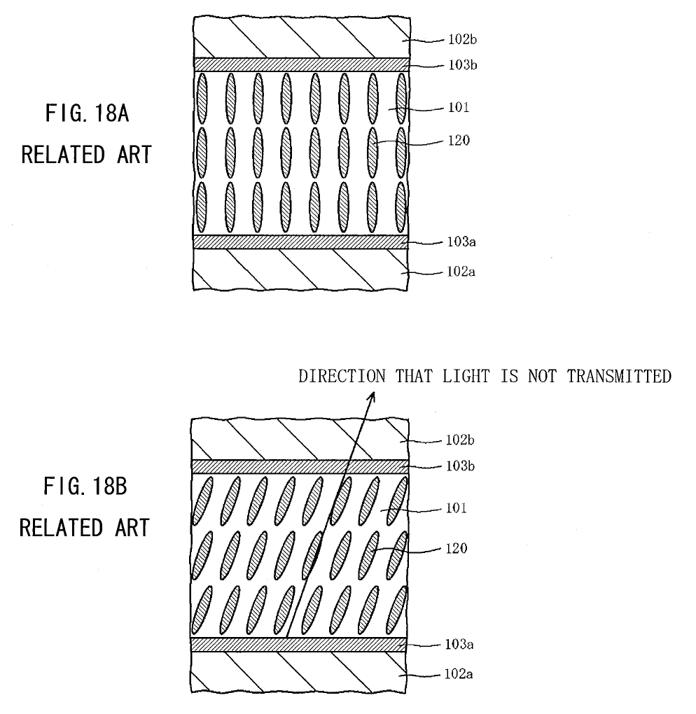

As described above, in the liquid crystal display device 10, in the time of light blocking when an electric field is not applied, the display-use liquid crystal molecules 11 are not totally aligned vertically to the substrate face. Further, in the vertical alignment film 4, the crystalline framework aligned tilted to the normal line direction of the transparent substrate 2 exists. Therefore, the light transmission factor in the time of light blocking becomes slightly larger than the minimum value determined by orthogonal nature of the polarization plates 6a and 6b, due to the optical anisotropy of the display-use liquid crystal molecules and the optical anisotropy of the liquid crystalline framework. As a result, compared to the liquid crystal display device in VA mode and the liquid crystal display device in PVA mode (refer to FIGS. 18A and 18B), contrast is slightly lowered. However, such contrast lowering is in a tolerable range, if the tilt of the display-use liquid crystal molecules 11 from the normal line direction is, for example, 0.1 to 5 degree, desirably 0.5 to 2.5 degree, and more desirably 0.8 to 1.5 degree. Further, if necessary, as a modified example described later, the contrast lowering is able to be kept to a minimum by adding an optical compensated layer for compensating the foregoing optical anisotropy.

The liquid crystal display device 10 is characterized in as follows. That is, the alignment direction of the display-use liquid crystal molecules 11 when an electric field is not applied is controlled to be slightly tilted to a given direction from the normal line direction of the transparent substrate 2 by the vertical alignment film 4. Therefore, when an electric field is applied, the tilt direction of the display-use liquid crystal molecules 11 is not irregular, and favorable operation characteristics and favorable optical characteristics as a liquid crystal display device are realized. Furthermore, the alignment of the all display-use liquid crystal molecules 11 are concurrently changed. Thus, compared to the liquid crystal display device in MVA mode or in PVA mode in which alignment of the other liquid crystal molecules is changed in a domino fashion, which is spread from partial liquid crystal molecules as the origin point, the response speed becomes higher.

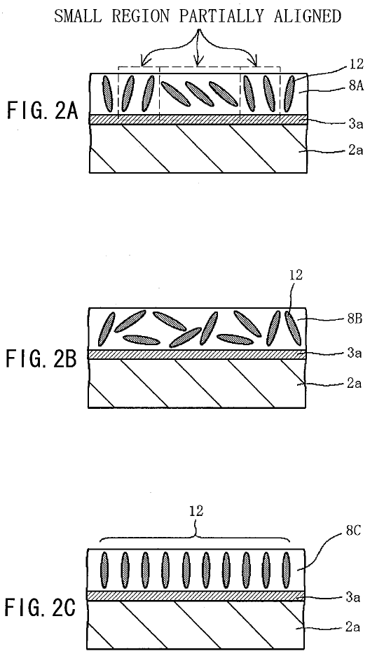

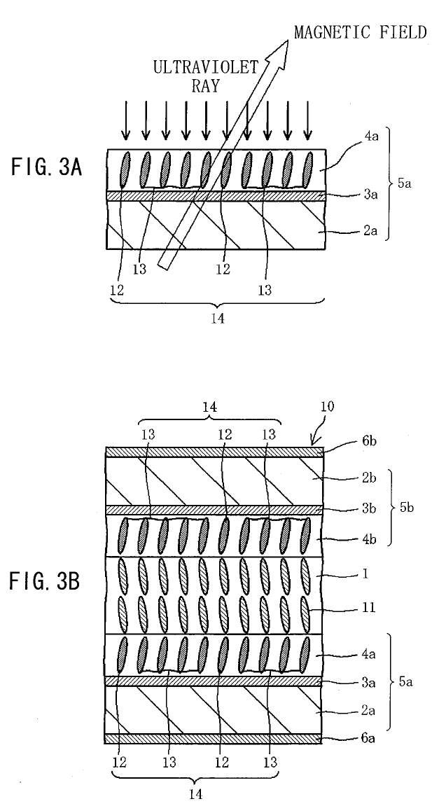

FIGS. 2A to 2C and FIGS. 3A and 3B are partial cross sectional views showing a flow of steps of forming the vertical alignment film 4, the vertical alignment substrate 5, and the liquid crystal display device 10 based on the first embodiment.

First, a solution in which the polymerizable liquid crystal molecules 12 are dissolved in an appropriate solvent is formed. As described before, the polymerizable liquid crystal molecules 12 are molecules that have the crystalline framework and that have characteristics to align the crystalline framework vertically to an interface with a dissimilar material. Further, in view of manufacture such as easiness of formation steps, the polymerizable liquid crystal molecules 12 are desirably molecules having large magnetic susceptibility, and desirably molecules having characteristics polymerizable by irradiation of ultraviolet ray As the polymerizable liquid crystal molecules 12 to satisfy the foregoing conditions, for example, 4-(4′-propyl)cyclohexyl-1-acryloyloxybenzene and 4-(p-propylphenyl)ethynyl-1-acryloyloxybenzene are used by mixture.

As the solvent to dissolve the polymerizable liquid crystal molecules 12, a known solvent is able to be used. Specially, a solvent that is highly dissolve the polymerizable liquid crystal molecules 12, has low vapor pressure at room temperature, and is hardly evaporated at room temperature is preferable. In the case where a solvent that is easily evaporated at room temperature is used, evaporation rate of the solvent after the transparent substrate 2 is coated with the solution of the polymerizable liquid crystal molecules 12 is excessively high. Thus, in a layer 8A of the polymerizable liquid crystal molecules 12 formed after evaporation of the solvent, alignment of the polymerizable liquid crystal molecules 12 is easily disordered. There is a tendency that such disorder is not able to be resolved even if alignment treatment in which the layer 8A is gradually cooled after heating the layer 8A up to temperature of liquid crystal-isotropic phase transition temperature described later is provided. An inappropriate solvent that is easily evaporated at room temperature is, for example, acetone, methanol, ethanol and the like. The solution of the polymerizable liquid crystal molecules 12 may be added with a polymerization initiator, a polymerization inhibitor, an interfacial active agent and the like.

The transparent substrate 2a provided with the transparent electrode 3a composed of ITO or the like is coated with the foregoing solution by spin coat method or the like. After that, the solvent is evaporated, and as shown in FIG. 2A, the layer 8a composed of the polymerizable liquid crystal molecules 12 is formed. In the layer 8a, the polymerizable liquid crystal molecules 12 are in a state of liquid crystal. However, the layer 8a is divided into many small regions. In each small region, though the alignment direction of the polymerizable liquid crystal molecules 12 is ordered, each alignment direction of the polymerizable liquid crystal molecules 12 varies according to each small region, and a defect such as disclination also exists.

Next, temperature of the layer 8A composed of the polymerizable liquid crystal molecules 12 is increased. Once the layer 8A is changed into a layer 8B in which the polymerizable liquid crystal molecules 12 are in a state of isotropic phase as shown in FIG. 2B, and then temperature of the layer 8B composed of the polymerizable liquid crystal molecules 12 is gradually lowered. Thereby, as shown in FIG. 2C, the layer 8b is changed into a layer 8C in which the polymerizable liquid crystal molecules 12 are in a state of liquid crystal. In the layer 8C, almost all the polymerizable liquid crystal molecules 12 in the wide range of regions are aligned vertically to the interface and in a state of one ordered liquid crystal, in a manner, “in a state of one united liquid crystal” in a wide range.

It was found that the small regions having each alignment direction of the polymerizable liquid crystal molecules 12 different from each other that existed in the layer 8A in the initial state by obtaining the layer 8B in a state of isotropic phase. After that, the layer 8B was gradually cooled while providing sufficient time for aligning the polymerizable liquid crystal molecules 12 in an optimal state. Thereby, the layer 8C in which almost all the polymerizable liquid crystal molecules 12 were ordered vertically to the interface and which were “in a state of one united liquid crystal” in a wide range was able to be formed.

Further, it was found that it was difficult to uniformly align the polymerizable liquid crystal molecules 12 in the layer 8A in a given direction by straightly applying a magnetic field to the layer 8A not in a state of uniform alignment, since, for example, the many small regions in which each alignment direction of the polymerizable liquid crystal molecules 12 was different from each other were formed. However, in the case where a magnetic field was applied after the layer 8B was changed into the layer 8C in which each alignment direction of each polymerizable liquid crystal molecule 12 in the layer was ordered vertically to the interface and which were “in a state of one united liquid crystal” as described above in the foregoing step, respective polymerizable liquid crystal molecules 12 in the layer 8C were able to be ordered and uniformly aligned in a given direction.

The reason thereof may be regarded as follows. In the case where a magnetic field is applied to the layer 8A in which each alignment direction of the polymerizable liquid crystal molecules 12 varies according to each small region described above, each angle made by the alignment direction of the polymerizable liquid crystal molecules 12 and the magnetic field direction varies according to each small region. Therefore, action given from the magnetic field to each polymerizable liquid crystal molecule 12 is not uniform. In addition, in the layer 8A not in a state of uniform vertical alignment, characteristics that each polymerizable liquid crystal molecule 12 regulates an alignment direction of other polymerizable liquid crystal molecule 12 by interaction between the liquid crystal molecules and behaves cooperatively are hardly expressed. As a result, in the layer 8A, the polymerizable liquid crystal molecules 12 hardly respond to application of the magnetic field, and an alignment structure of the polymerizable liquid crystal molecules 12 aligned in the magnetic field application direction is hardly formed. If formed, a surface structure having large variation of the alignment direction of the polymerizable liquid crystal molecules 12 is formed. The vertical alignment film formed from such a layer has insufficient performance to regulate the alignment direction of the display-use liquid crystal molecules 11 arranged contacted with the surface thereof in a certain direction.

Meanwhile, in the case where a magnetic field is applied to the layer 8C in which the polymerizable liquid crystal molecules 12 in the layer are vertically aligned uniformly and are “in a state of one united liquid crystal” as described above, each angle made by the alignment direction of the polymerizable liquid crystal molecules 12 and the magnetic field direction is the same as each other. Action given from the magnetic field to each polymerizable liquid crystal molecule 12 is uniform. In addition, in the layer 8C in a state of uniform vertical alignment, characteristics that each polymerizable liquid crystal molecule 12 regulates an alignment direction of other polymerizable liquid crystal molecule 12 by interaction between the liquid crystal molecules and behaves cooperatively are strongly expressed. As a result, the alignment of the entire polymerizable liquid crystal molecule 12 in the layer 8C is changed as a so-called elastic continuum. Therefore, an alignment structure of the polymerizable liquid crystal molecules 12 aligned in the magnetic field application direction is easily formed. Further, a surface structure having an uniaxial anisotropy having small variation of the alignment direction of the polymerizable liquid crystal molecules 12 is formed. The vertical alignment film formed from such a layer has high performance to regulate the alignment direction of the display-use liquid crystal molecules 11 arranged contacted with the surface thereof.

Next, as shown in FIG. 3A, the director of the polymerizable liquid crystal molecules 12 is aligned in a direction slightly tilted from the normal line direction of the transparent substrate 2a, for example, in the direction tilted by 0.1 to 5 degree, desirably by 1 to 10 degree, and more desirably by 1 to 5 degree by applying a magnetic field of, for example, about 1T (tesla) to the layer 8C composed of the polymerizable liquid crystal molecules kept in a state of liquid crystal in a direction tilted from the normal line direction of the transparent substrate 2a. In this state, the layer 8C is irradiated with ultraviolet ray, at least part of the polymerizable liquid crystal molecules 12 is polymerized, and the layer 8C composed of the polymerizable liquid crystal molecules is changed into the layer formed from the complex 14 composed of the unreacted polymerizable liquid crystal molecules 12 and the polymerizable liquid crystal molecule polymer 13, and hardened.

As described above, the vertical alignment film 4a composed of the complex 14 in which the alignment direction of the director is fixed in the direction slightly tilted from the normal line direction of the substrate 2a is able to be formed on the transparent substrate 2a, and the vertical alignment substrate 5a including the vertical alignment film 4a is able to be formed.

A method to align the crystalline framework of the polymerizable liquid crystal molecules 12 in a given direction is not particularly limited. In addition to applying the magnetic field, applying an electric field or the like is cited. However, applying the magnetic field is most preferable, since it is easily controlled. Further, a method of polymerizing the polymerizable liquid crystal molecules 12 is not particularly limited. In addition to radiation of ultraviolet ray, radiation of infrared ray or electron ray, and/or a method such as heating are cited. However, radiation of ultraviolet ray is most preferable, since therewith various polymerizable liquid crystal molecules 12 are able to be applied and it is easy to implement it.

Next, as shown in FIG. 3B, the foregoing transparent substrate 2a and the transparent substrate 2b for which the vertical alignment film 4b was formed similarly are opposed with an (not-shown) spacer in between. Ends are sealed with a sealing member to form a housing (empty cell) of the liquid crystal cell 9. The display-use liquid crystal molecules 11 forming the liquid crystal layer 1 is injected into the housing to form the liquid crystal cell 9. Then, as described above, each alignment direction of the director in the two vertical alignment films 4a and 4b is set to be in parallel with each other.

After that, the polarization plates 6a and 6b are arranged in a state of cross nicol on the outer surface of the transparent substrates 2a and 2b to form the liquid crystal display device 10.

As described above, according to the method of manufacturing a vertical alignment film based on this embodiment, the polymerizable liquid crystal molecules 12 are the molecules having the characteristics to align the director vertically to an interface with a dissimilar material. Therefore, in the layer 8C composed of the polymerizable liquid crystal molecules 12, the polymerizable liquid crystal molecules 12 are able to be aligned so that the director is vertical to the interface with a vapor phase and the interface with the transparent substrate 2. In addition, it is possible to easily perform the step in which a magnetic field or the like is applied to the layer 8C to align the crystalline framework in the direction slightly tilted from the normal line direction. Then, in some cases, a structure to support the vertical alignment of the polymerizable liquid crystal molecules 12 may be desirable. However, a structure to damage the vertical alignment should be avoided. For example, in the case where a supplementary layer is provided on the surface of the transparent substrate 2 as in Japanese Patent No. 3572787, the material is limited to a vertical alignment type organic resin material (polyimide or the like) or a silane coupling agent vertical alignment material.

Further, the polymerizable liquid crystal molecules 12 are the polymerizable molecules. Therefore, it is possible that at least part of the polymerizable liquid crystal molecules 12 is polymerized in the foregoing state that the crystalline framework is aligned, and thereby the layer composed of the polymerizable liquid crystal molecules 12 is changed into the layer formed from the complex 14 composed of the unreacted polymerizable liquid crystal molecules 12 and the polymerizable liquid crystal molecule polymer 13, and the alignment of the crystalline framework is fixed.

Accordingly, the vertical alignment film 4 in which the alignment of the crystalline framework is well ordered is able to be surely manufactured.

Meanwhile, the methods of manufacturing an alignment film proposed in Japanese Unexamined Patent Application Publication No. 2-43517 and Japanese Patent No. 3572787, as clearly described in each document, the methods are intended to form a horizontal alignment film, and not intended to form a vertical alignment film. Therefore, the main chain type liquid crystal polymer used in Japanese Unexamined Patent Application Publication No. 2-43517 and the polymerizable liquid crystalline monomer used in Japanese Patent No. 3572787 are structured to be lined almost in parallel with the substrate before performing alignment treatment by a magnetic field or the like. Therefore, the horizontal alignment film having a pretilt angle of about 10 degree is able to be easily formed. Meanwhile, it is not possible that a vertical alignment film having a pretilt angle close to 90 degree from such a main chain liquid crystal polymer or such a polymerizable liquid crystalline monomer that are lined almost in parallel with the substrate only by changing application direction of a magnetic field or an electric field.

For example, to align liquid crystalline polymers lined almost in parallel with a substrate in a self-organization fashion almost vertically to the substrate against the characteristics, a strong magnetic field or the strong electric field is demanded. In the case where the crystalline molecules are a polymer as in Japanese Unexamined Patent Application Publication No. 2-43517, such a demand is particularly significant. Further, if such a strong magnetic field or the strong electric field is able to be applied, in the case where alignment change close to 90 degree is generated, it is not possible to uniformly and precisely order alignment directions of all the liquid crystalline molecules (it is evident from existing examples of driving display-use liquid crystal molecules). Variation in alignment directions of the liquid crystalline molecules in the alignment film causes variation in alignment directions of the display-use liquid crystal molecules arranged contacted therewith. As a result, in the liquid crystal display device in VA mode, variation in alignment directions of the display-use liquid crystal molecules in the time of blocking when a voltage is not applied is generated, the light transmission factor of the liquid crystal layer is increased, and the contrast is lowered. Accordingly, characteristics of the liquid crystal display device in VA mode may be fatally damaged.

Further, the step of polymerizing the polymerizable liquid crystalline monomer, and then washing and removing the unreacted material with the organic solvent to leave only the polymer layer, and thereby obtaining the alignment film described in Japanese Patent No. 3572787 may be effective for manufacturing the horizontal alignment film in which the polymerizable liquid crystalline monomer and the polymer thereof are lining in parallel with the substrate. However such a step is not applicable for manufacturing a vertical alignment film. If applicable, such a step gives no effect. In the vertical alignment film, as in the present application, it is enough that the layer formed from the complex 14 composed of the unreacted polymerizable liquid crystal molecules 12 and the polymerizable liquid crystal molecule polymer 13 is directly used as the vertical alignment film 4. That is, if alignment of the crystalline framework is fixed, the both polymerizable liquid crystal molecules 12 and the polymerizable liquid crystal polymer 13 may be used to align the display-use liquid crystal molecules 11.

4-acryloyloxy-4′-butyl-bicyclohexyl and the like that is exemplified as a suitable polymerizable liquid crystalline monomer in Japanese Patent No. 3572787 are liquid crystal molecules having characteristics to be aligned vertically to an interface with other material that is suitable as the polymerizable liquid crystal molecules. In the case where the polymerizable liquid crystalline monomer having such vertical alignment characteristics is used, though not clearly described in Japanese Patent No. 3572787, it is conceivable that an additional structure to align the polymerizable liquid crystalline monomer almost in parallel with the substrate, for example, coating the substrate surface with a horizontal alignment film or a silane coupling horizontal alignment material is always performed.

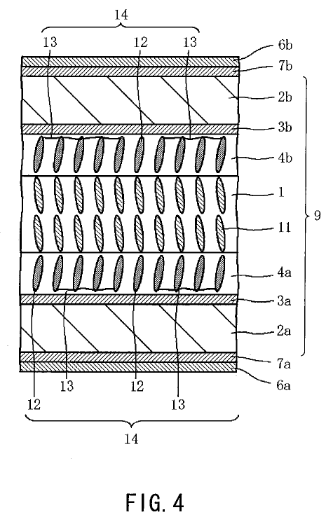

FIG. 4 is a partial cross sectional view showing a structure of a liquid crystal display device based on a modified example of the first embodiment. FIG. 4 shows an alignment state of the display-use liquid crystal molecules 11 when an electric field is not applied. The liquid crystal display device corresponds to the liquid crystal display device described in claim 34. In the liquid crystal display device, an optical compensated layer 7 to eliminate optical anisotropy generated by the vertical alignment film 4 and the display-use liquid crystal molecules 11 when an electric field is not applied is provided between the transparent substrate 2 and the polarization plate 6. The other structures are the same as those of the liquid crystal display device 10 shown in FIGS. 1A and 1B.

As described before, in the liquid crystal display device 10, in the time of light blocking when an electric field is not applied, the display-use liquid crystal molecules 11 are not totally aligned vertically to the face of the transparent substrate 2. Further, in the vertical alignment film 4, the liquid crystalline framework aligned slightly tilted to the normal line direction of the transparent substrate 2 exists. Therefore, the light transmission factor in the time of light blocking is slightly larger than the minimum value determined by orthogonal nature of the polarization plates 6a and 6b due to the optical anisotropy of the display-use liquid crystal molecules 11 and the optical anisotropy of the liquid crystalline framework in the vertical alignment film 4.

The optical compensated layer 7 is intended to eliminate the optical anisotropy belonging to the liquid crystal cell 9 described above so that the light transmission factor in the time of light blocking is close to the minimum value determined by orthogonal nature of the polarization plates 6a and 6b as much as possible. By adding the optical compensated layer 7, contrast lowering due to the optical anisotropy belonging to the liquid crystal cell 9 is able to be kept to a minimum. The optical compensated layer 7 is able to be formed from a negative C plate having the same alignment direction as that of the vertical alignment film 4 or the like.

FIG. 4 shows an example in which the optical compensated layers 7a and 7b are respectively provided for the both transparent substrates 2a and 2b. However, the optical compensated layer may be provided only for one of the transparent substrates 2a and 2b.

### Second Embodiment

In the second embodiment, descriptions will be mainly given of a vertical alignment film according to claim 9, a method of manufacturing it according to claim 25, and a liquid crystal display device provided with the vertical alignment film. A liquid crystal display device composing a liquid crystal television or the like is expected to have wide view angle characteristics. In the past, as a technology to address such a task, multidomain by MVA mode or PVA mode has been known. In the second embodiment, a vertical alignment film in each pixel is formed as a pattern composed of a plurality of domains in which the liquid crystalline framework is aligned in different directions, and a liquid crystal display device having wide view angle characteristics is realized.

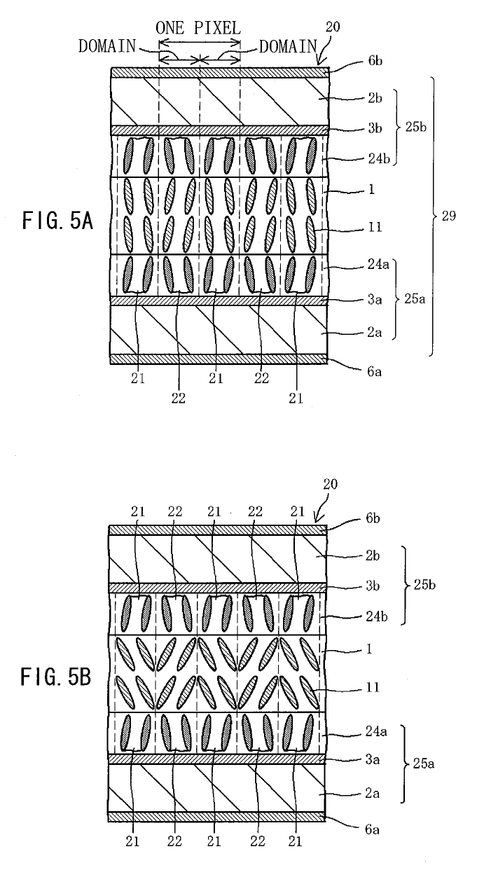

FIGS. 5A and 5B are partial cross sectional views showing structures of the vertical alignment film, a vertical alignment substrate, and the liquid crystal display device according to the second embodiment. A liquid crystal display device 20 is structured as a liquid crystal display device that works in VA mode. FIG. 5A shows an alignment state of the display-use liquid crystal molecules 11 when an electric field is not applied.

In the liquid crystal display device 20, in the same manner as that of the liquid crystal display device 10, a liquid crystal cell 29 is formed from the liquid crystal cell 1 and the pair of transparent substrates 2a and 2b oppositely arranged with the liquid crystal layer 1 in between. On the outer face sides of the transparent substrates 2a and 2b, the pair of polarization plates 6a and 6b are respectively arranged. The transparent substrates 2a and 2b are made of a glass substrate or the like. On the inner face side of the transparent substrate 2a, the transparent electrode 3a and a vertical alignment film 24a are formed. On the inner face side of the transparent substrate 2b, an (not-shown) color filter composed of three primary colors R (red), G (green), and B (blue), the transparent electrode 3b, a vertical alignment film 24b are formed. The transparent electrodes 3a and 3b are composed of, for example, ITO or the like. The transparent substrate 2a and the transparent substrate 2b respectively provided with the vertical alignment film 24a and the vertical alignment film 24b are a vertical alignment substrate 25a and a vertical alignment substrate 25b.

In the liquid crystal device 20, in correspondence with claim 9, in each pixel, a complex layer composing the vertical alignment film 24 is formed as a pattern composed of a plurality of regions (domains) in which each tilt direction of the crystalline framework is different from each other. The other structures are the same as those of the liquid crystal display device 10 shown in FIGS. 1A and 1B. Therefore, descriptions will be hereinafter given with an emphasis on the differences avoiding overlap.

As the vertical alignment film 4 of the liquid crystal display device 10, the vertical alignment film 24 is formed from, as a starting point, a layer composed of the polymerizable liquid crystal molecules 12, and is formed from a layer composed of a complex of the polymerizable liquid crystal molecules 12 and the polymerizable liquid crystal molecule polymer 13. However, as shown in FIG. 5A, the vertical alignment film 24 is formed as a pattern composed of a region (domain) formed from a complex 21 in which the director alignment direction in the complex is fixed in a direction slightly tilted to the right side from the normal line direction of the transparent substrate 2, for example, in a direction tilted by 0.1 to 5 degree to the right side; and a region (domain) as bilaterally symmetric region to the former region, which is formed from a complex 22 in which the director alignment direction in the complex is fixed in a direction slightly tilted to the left side from the normal line direction of the transparent substrate 2 in each pixel.

When an electric field is not applied, each crystalline framework of each region (domain) aligns the long axis of the display-use liquid crystal molecules 11 in a direction corresponding to a director tilt by interaction between the liquid crystal molecules. As a result, in each pixel, the display-use liquid crystal molecules 11 on each region (domain) are aligned in a direction slightly tilted from the normal line direction of the transparent substrate 2, for example, in a direction tilted by 0.1 to 5 degree in a bilaterally-symmetric fashion. FIG. 5A shows an example in which the crystalline framework in the vertical alignment film 4 aligns the display-use liquid crystal molecules 11 tilted in the direction opposite to the tilt direction of the liquid crystalline framework in relation to the normal line direction of the transparent substrate 2.

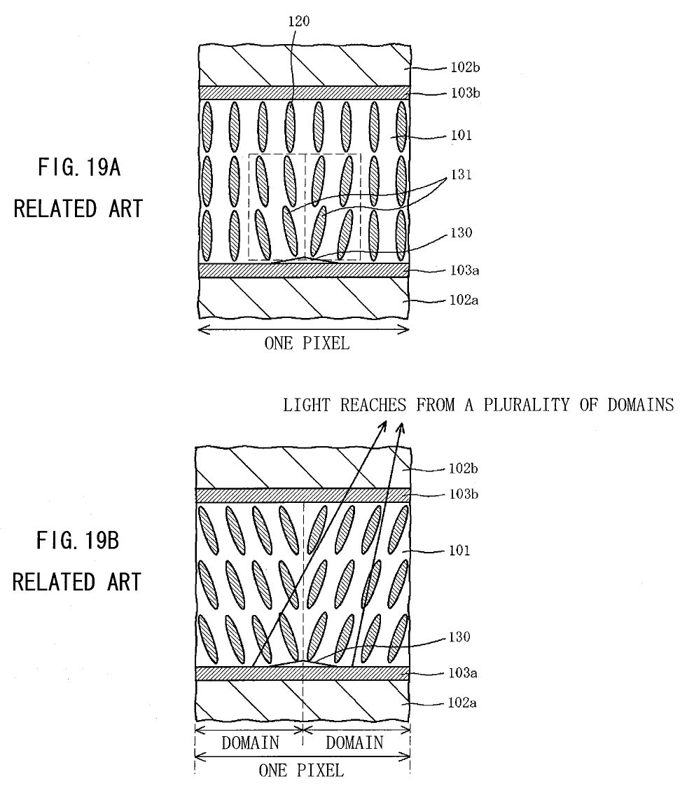

Therefore, when a voltage is applied between the transparent electrode 3a and the transparent electrode 3b and an electric field is applied to the display-use liquid crystal molecules 11, as shown in FIG. 5B, the display-use liquid crystal molecules 11 change the alignment direction close to a state that the long axis thereof is aligned approximately vertically to the electric field direction (state that the long axis is aligned in parallel with the substrate face). Then, the display-use liquid crystal molecules 11 on each region (domain) respectively change the alignment direction in a bilaterally-symmetric fashion. As in MVA mode shown in FIG. 19B, in the state of FIG. 5B, even if a liquid crystal screen is viewed from an oblique direction, light passing the liquid crystal molecules 11 in which each tilt direction is opposite to each other reaches the screen from the plurality of domains in one pixel. Therefore, angle dependence is averaged, and view angle dependence is kept small.

FIGS. 5A and 5B show an example that two domains are formed in a bilaterally-symmetric fashion. However, it is possible that an pixel is formed into multi-domains more intricately, for example, domains may be also formed right and left in a bilaterally-symmetric fashion, and thereby view angle dependence of the liquid crystal display device may be further kept small.

FIGS. 5A and 5B show an example in which the vertical alignment films 24a and 24b are respectively provided for the both transparent substrates 2a and 2b, and each alignment direction of the liquid crystalline framework in each film located oppositely is in parallel with each other in the two vertical alignment films 24a and 24b. In this case, the alignment direction of the long axis of the display-use liquid crystal molecules 11 controlled by the two vertical alignment films 24a and 24b becomes in parallel therewith, and the display-use liquid crystal molecules 11 are aligned uniformly tilted from the normal line direction of the main face of the transparent substrate 2. Though. FIGS. 5A and 5B show an example that the vertical alignment film is provided for the both transparent substrates 2a and 2b, the vertical alignment film may be provided for only one of the transparent substrates 2a and 2b.

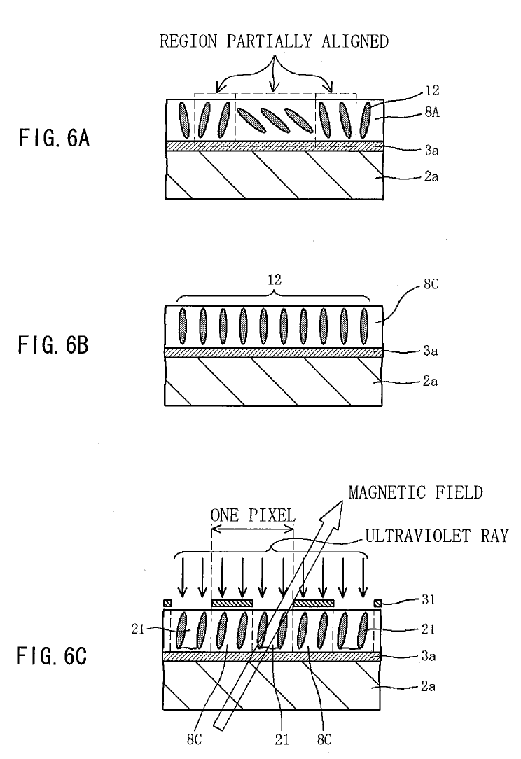

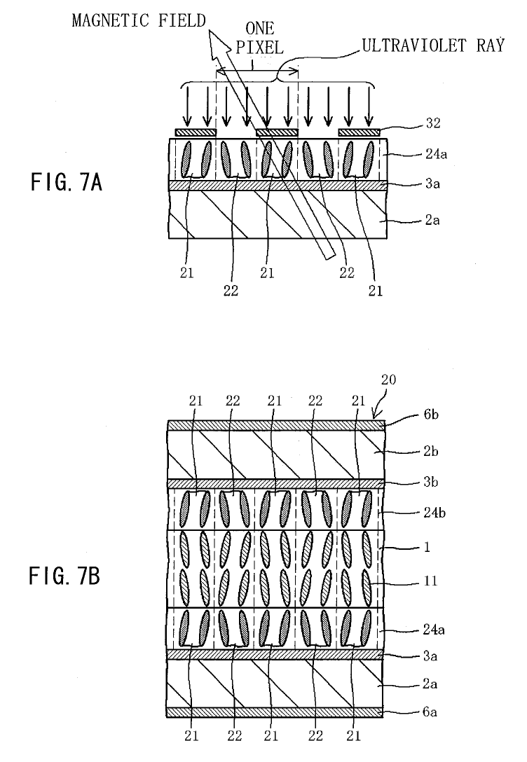

FIGS. 6A to 6B and FIGS. 7A to 7B are partial cross sectional views showing a flow of steps of forming the vertical alignment film 24, the vertical alignment substrate 25, and the liquid crystal display device 20 based on the second embodiment. Descriptions will be hereinafter given with an emphasis on the differences from steps of forming the liquid crystal display device 10 avoiding overlap with the first embodiment.

First, in the same manner as that of the first embodiment, a solution in which the polymerizable liquid crystal molecules 12 are dissolved in an appropriate solvent is formed. The transparent substrate 2a provided with the transparent electrode 3a composed of ITO or the like is coated with the solution. After that, the solvent is evaporated, and as shown in FIG. 6A, the layer 8a composed of the polymerizable liquid crystal molecules 12 is formed. In the layer 8a, the polymerizable liquid crystal molecules 12 are in a state of liquid crystal. However, the layer 8a is divided into many small regions. In each small region, though the alignment direction of the polymerizable liquid crystal molecules 12 is ordered, each alignment direction of the polymerizable liquid crystal molecules 12 varies according to each small region, and a defect such as disclination also exists.

Next, temperature of the layer 8A composed of the polymerizable liquid crystal molecules 12 is increased. Once the polymerizable liquid crystal molecules 12 are changed into a state of isotropic phase, and then temperature is gradually lowered. Thereby, as shown in FIG. 6B, the layer 8A is changed into the layer 8C in which the polymerizable liquid crystal molecules 12 are in a state of liquid crystal. In the layer 8C, almost all the polymerizable liquid crystal molecules 12 are aligned vertically to the interface and in a state of one ordered liquid crystal, in a manner, “in a state of one united liquid crystal” in a wide range.

Next, as shown in FIG. 6C, the crystalline framework of the polymerizable liquid crystal molecules 12 is aligned in a direction slightly tilted from the normal line direction of the transparent substrate 2a, for example, in the direction tilted by 0.1 to 20 degree, desirably by 1 to 10 degree, and more desirably by 1 to 5 degree by applying a magnetic field of, for example, about 1T (tesla) to the layer 8C composed of the polymerizable liquid crystal molecules kept in a state of liquid crystal in a direction tilted from the normal line direction of the transparent substrate 2a. In this state, the region in a right half in each pixel is selectively irradiated with ultraviolet ray by using a photo mask 31, and at least part of the polymerizable liquid crystal molecules 12 in this region is polymerized, and the layer 8C composed of the polymerizable liquid crystal molecules in this region is changed into a layer formed from the complex 21 composed of the unreacted polymerizable liquid crystal molecules 12 and the polymerizable liquid crystal molecule polymer 13, and hardened. Thereby, the alignment direction of the liquid crystalline framework in the complex 21 is fixed.

Next, as shown in FIG. 7A, a magnetic field is applied symmetrically to the former direction, and thereby the crystalline framework of the unhardened polymerizable liquid crystal molecules 12 occupying the region of a left half in each pixel is aligned symmetrically to the former direction. In this state, the region in the left half in each pixel is selectively irradiated with ultraviolet ray by using a photo mask 32, and at least part of the polymerizable liquid crystal molecules 12 in this region is polymerized, and the layer 8C composed of the polymerizable liquid crystal molecules in this region is changed into a layer formed from a complex 22 composed of the unreacted polymerizable liquid crystal molecules 12 and the polymerizable liquid crystal molecule polymer 13, and hardened. Thereby, the alignment direction of the liquid crystalline framework in the complex 22 is fixed.

Accordingly, as a vertical alignment film, the vertical alignment film 24a in which the complexes 21 and 22 in which the alignment direction of the crystalline framework is fixed in the direction slightly tilted from the normal line direction of the transparent substrate 2a and the tilt direction is symmetrical to each other are formed as a pattern in each pixel is able to be formed. In addition, the transparent substrate 2a in which the vertical alignment film 24a is formed is able to be formed as a vertical alignment substrate.

Next, as shown in FIG. 7B, the foregoing transparent substrate 2a and the transparent substrate 2b for which the vertical alignment film 24b is formed similarly are opposed with an (not-shown) spacer in between. Ends are sealed with a sealing member to form a housing (empty cell) of the liquid crystal cell 25. The display-use liquid crystal molecules 11 forming the liquid crystal layer 1 are injected into the housing to form the liquid crystal cell 25. Then, as described above, each alignment direction of the liquid crystalline framework in the two vertical alignment films 24a and 24b is set to be in parallel with each other.

After that, the polarization plates 6a and 6b are arranged in a state of cross nicol on the outer surface of the transparent substrates 2a and 2b to form the liquid crystal display device 20.

A method to align the crystalline framework of the polymerizable liquid crystal molecules 12 in a given direction is not particularly limited, In addition to applying the magnetic field, applying an electric field or the like is cited. However, applying the magnetic field is most preferable, since it is easily controlled. Further, a method of polymerizing the polymerizable liquid crystal molecules 12 is not particularly limited. In addition to radiation of ultraviolet ray, radiation of infrared ray or electron ray, and/or a method such as heating are cited. However, radiation of ultraviolet ray is most preferable, since therewith various polymerizable liquid crystal molecules are able to be applied and it is easy to implement it.

As described above, according to the second embodiment, each pixel is easily and surely changed into a state of multidomain, and thereby the liquid crystal display device 20 having wide view angle characteristics is able to be realized. In the other points such as slow response speed, the liquid crystal display device 20 has characteristics similar to those of the liquid crystal display device 10.

### EXAMPLES

Examples will be hereinafter described. The following examples are illustrative only, and the present application is not limited to the examples.

In Examples 1 and 2, first, the vertical alignment film 4 and the vertical alignment substrate 5 described in the first embodiment with the use of FIGS. 1A and 1B were formed. Retardation of the vertical alignment substrate was measured by changing the tilt angle (angle made by the normal line direction of the transparent substrate 2 and the measurement direction) variously. Thereby, the alignment direction of the crystalline framework was determined. Subsequently, the liquid crystal cell 9 was formed. Retardation of the liquid crystal cell 9 was measured by changing the tilt angle variously, and the difference with the retardation of the vertical alignment substrate was obtained, and thereby the arrangement direction of the display-use liquid crystal molecules 11 was determined.

### Forming the Vertical Alignment Film and the Vertical Alignment Substrate

### Example 1

First, as the polymerizable liquid crystal molecules 12 containing a polymerization initiator, UCL-011-K1, Dainippon Ink And Chemicals, Incorporated make was dissolved at a concentration of 30 wt % in 1-methoxy-2-acetoxypropane (PGMEA) as a solvent to form a solution. A glass substrate (thickness: 1.1 mm) as the transparent substrate 2 provided with the transparent electrode 3 composed of ITO was coated with the solution by spin coat method (number of revolutions: 5000 rpm) to form the layer 8A composed of the polymerizable liquid crystal molecules 12.

Next, temperature of the layer 8A was increased up to 70 degree C., at which the layer 8A was retained for 10 minutes to once change the polymerizable liquid crystal molecules 12 to the layer 8B in a state of isotropic phase. After that, temperature was gradually lowered at a rate of about 10 degree C./minute down to 55 degree C. Further, temperature was gradually lowered at a rate of about 10 degree C./minute down to 40 degree C. Finally, temperature was returned to room temperature to form the liquid crystal layer 8C in which the polymerizable liquid crystal molecules 12 were uniformly aligned vertically to the interface. A cross section of the vertical alignment film substrate similarly formed was observed by using a scanning electron microscope. As a result, the thickness of the liquid crystal layer 8C was 300 nm.

Next, the crystalline framework of the polymerizable liquid crystal molecules 12 was aligned in a direction slightly tilted from the normal line direction of the substrate by applying a magnetic field of 1.4 T (tesla) in a direction tilted by 28 degree from the normal line direction of the transparent substrate 2 to the liquid crystal layer 8C for 7 minutes. In this state, the liquid crystal layer 8C was irradiated with ultraviolet ray from an orthogonal direction of the rear face of the substrate 2, part of the polymerizable liquid crystal molecules 12 is polymerized under nitrogen atmosphere, and a hardened layer formed from the complex 14 composed of the unreacted polymerizable liquid crystal molecules 12 and the polymerizable liquid crystal molecule polymer 13 was formed as the vertical alignment film 4. The vertical alignment film 4 of the vertical alignment substrate 5 of Example 1 formed as above was observed by a polarization microscope. As a result, it was black under cross nicol, and even when the vertical alignment film substrate was rotated, tone was not changed and it was in a state of mono domain.

### Example 2

A vertical alignment film was formed and observed in the same manner as that of Example 1, except that the concentration of the solution in which the polymerizable liquid crystal molecules 12 were dissolved was 20 wt %. The film thickness of the vertical alignment film was 230 nm. The observation result by a polarization microscope was similar to that of Example 1.

### Comparative Example 1

A vertical alignment film and a vertical alignment substrate of Comparative example 1 were formed in the same manner as that of Example 1, except that the liquid crystal layer 8C was hardened by irradiation of ultraviolet ray without applying a magnetic field. The formed vertical alignment film was observed by a polarization microscope in the same manner as that of Example 1. As a result, it was black under cross nicol, and even when the vertical alignment film substrate was rotated, tone was not changed and it was in a state of mono domain.

### Comparative Example 2

A vertical alignment film was formed in the same manner as that of Example 1, except that temperature of the layer 8A of the polymerizable liquid crystal molecules 12 was increased up to 70 degree C., at which the layer 8A was retained for 5 minutes, and then temperature was lowered at a rate of about 30 degree C./minute down to room temperature. The formed vertical alignment film was observed by using a polarization microscope in the same manner as that of Example 1. As a result, the following was found. A bright region existed partially, and when the vertical alignment substrate was rotated, the tone was changed. That is, the alignment direction of the polymerizable liquid crystal molecules 12 was not vertical, and an in-plane tilted component existed. Further, the direction thereof was partially different and it was not in a state of mono domain.

### Comparative Example 3

A vertical alignment film was formed in the same manner as that of Example 1, except that a solution of the polymerizable liquid crystal molecules 12 was prepared by using acetone as a solvent. In this case, after the substrate was coated with the solution by spin coat method, alignment unevenness of the polymerizable liquid crystal molecules 12 was generated. The alignment unevenness was not resolved by subsequent heat treatment.

### Measurement of Retardation of the Vertical Alignment Substrate

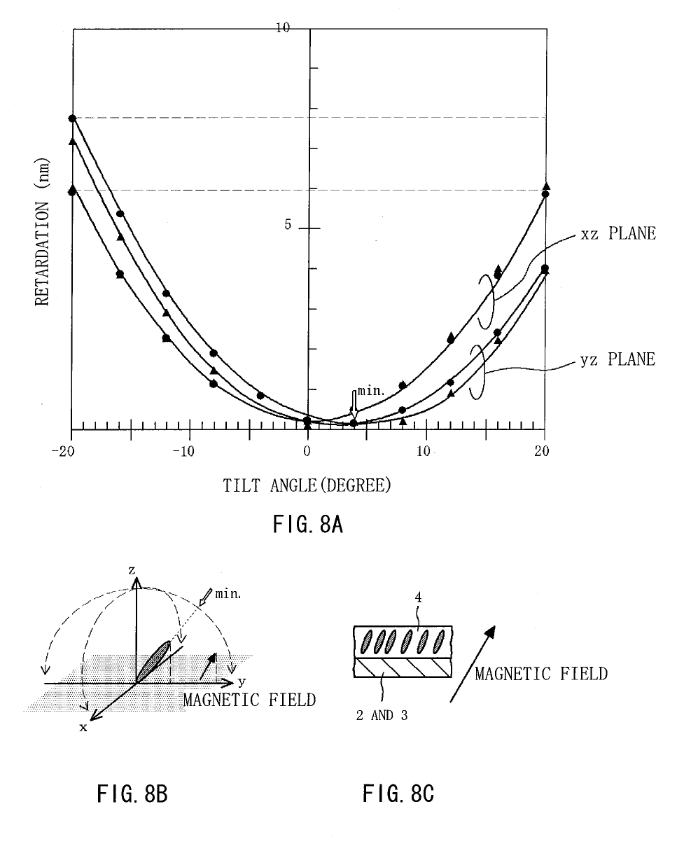

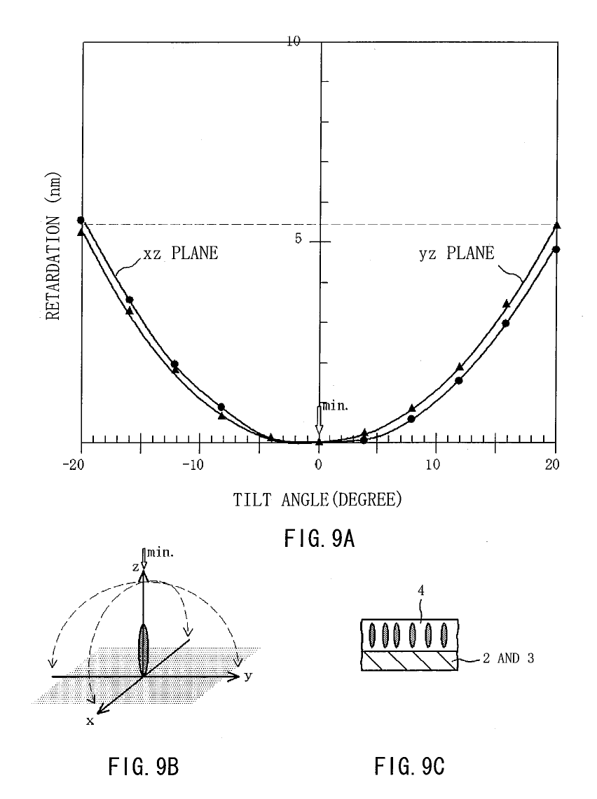

For the vertical alignment substrate 5 of Example 1 and the vertical alignment substrate of Comparative example 1, the retardation characteristics were measured by variously changing a tilt angle, that is, an incidence angle. The measurement was performed by using a fast spectroscopic ellipsometer M-2000, Woollam Co. (United States) make and incident light with a wavelength of 589 nm. Then, the measurement was performed for a case that the tilt angle was changed in the plane (yz plane) including the substrate normal line direction and a magnetic field application direction in forming the vertical alignment substrate 5, and a case that the tilt angle was changed in the plane (xz plane) vertical to the yz plane. FIG. 8A is a graph showing a measurement result of the vertical alignment substrate of Example 1, FIG. 8B is an, explanation diagram showing the measurement direction, and FIG. 8C is a cross sectional view of the vertical alignment substrate 5. FIG. 8A shows the result in the case of two pieces of vertical alignment substrates 5a and 5b used for one cell. FIG. 9A is a graph showing a measurement result of the vertical alignment substrate of Comparative example 1, FIG. 9B is an explanation diagram showing the measurement direction, and FIG. 8C is a cross sectional view of the vertical alignment substrate.

As shown in FIG. 9A, in the vertical alignment substrate of Comparative example 1, even when the tilt angle was changed in the plane including the substrate normal line direction and the like (refer to FIG. 9B), the substantially same results were obtained. That is, retardation of the vertical alignment substrate was the minimum value 0 in the case where the tilt angle was 0 degree, and retardation was increased symmetrically in the case where the tilt angle was changed in either positive direction or the negative direction from such a direction. The reason thereof was that, as shown in FIG. 9B, the crystalline framework of the polymerizable liquid crystal molecules 12 and the polymer 13 thereof were aligned vertically to the transparent substrate 2. For retardation of the vertical alignment substrate of Comparative example 2 and Comparative example 3, variation was extremely high according to the tilt angle, the tilt orientation, and the measurement position, and the retardation was not uniform but variation existed in a circular retardation measurement area being 4 mm in diameter.

Meanwhile, as shown in FIG. 8A, in the vertical alignment substrate of Example 1, the result in the case that the tilt angle was changed in the plane (yz plane) including the substrate normal line direction and the magnetic field application direction was different from the result of the case that the tilt angle was changed in the xz plane perpendicular to the yz plane (refer to FIG. 8B). That is, in the yz plane including the magnetic application direction, retardation of the vertical alignment substrate was the minimum value 0 in the case where the tilt angle was 4.0 degree, and retardation was increased symmetrically in the case where the tilt angle was changed in either positive direction or the negative direction from such a direction. Meanwhile, in the xz plane, retardation of the vertical alignment substrate was the minimum value 0 in the case where the tilt angle was 0 degree, and retardation was increased symmetrically in the case where the tilt angle was changed in either positive direction or the negative direction from such a direction. However, in this case, the minimum value was extremely close to 0, but did not become strictly 0. The result shows that, as shown in FIG. 8B, the crystalline framework of the polymerizable liquid crystal molecules 12 and the polymer 13 thereof was aligned tilted to the magnetic field application direction from the normal line direction of the transparent substrate 2, and that the crystalline framework was not tilted to the x-axis direction. For the vertical alignment substrate 5 of Example 2, similar measurement was performed, and a result corresponding to the measurement result of the vertical alignment substrate 5 of Example 1 within the error tolerance range was obtained. Therefore, for the vertical alignment substrate 5 of Example 2, it became evident that the crystalline framework of the polymerizable liquid crystal molecules 12 and the polymer 13 thereof was aligned to the magnetic field application direction from the normal line direction of the transparent substrate 2, and that the crystalline framework was not tilted to the x-axis direction. In the case where light enters a medium having high refractive index from the air, the light passes through the medium having high refractive index at an angle smaller than the incidence angle. Strictly speaking, it is necessary to perform calculation considering refractive index anisotropy. However, the approximate value thereof is able to be obtained by Snell's law. Since the tilt angle was 4.0 degree in Example 1, it was obtained that the average director direction was tilted by about 2.6 degree to the magnetic field application direction from the normal line direction of the transparent substrate 2.

### Forming the Liquid Crystal Cell.

### Examples 1 and 2

The two vertical alignment films 5a and 5b in which the vertical alignment film 4 was formed were oppositely arranged with a spacer in between. Ends are sealed with a sealing member to form a housing (empty cell) of the liquid crystal cell 9. As the display-use liquid crystal molecules 11, negative liquid crystal MLC-2037 (Merck Ltd. make) in a state of isotropic phase at 80 degree C. was injected into the housing to form the liquid crystal cell 9. The cell gap of the liquid crystal layer 1 was 12.0 μm.

### Comparative Examples 1 to 3

A liquid crystal cell of Comparative example 1 was formed in the same manner as that of Examples 1 and 2, except that the vertical alignment substrate for which the vertical alignment film of the comparative example was used instead of the vertical alignment substrate 5. In Comparative examples 2 and 3, a liquid crystal cell was formed in the same manner as that of Comparative example 1.

### Observation of the Liquid Crystal Cell

Observation of the external appearance of the liquid crystal cell in a state of cross nicol and observation thereof by a polarization microscope were performed. The liquid crystal cells formed in Examples 1 and 2 and Comparative example 1 were observed by the polarization microscope. As a result, even when the sample was rotated under cross nicol, tone was not generated, and light was extinct. In the case where the observation position was changed, a similar result was obtained.

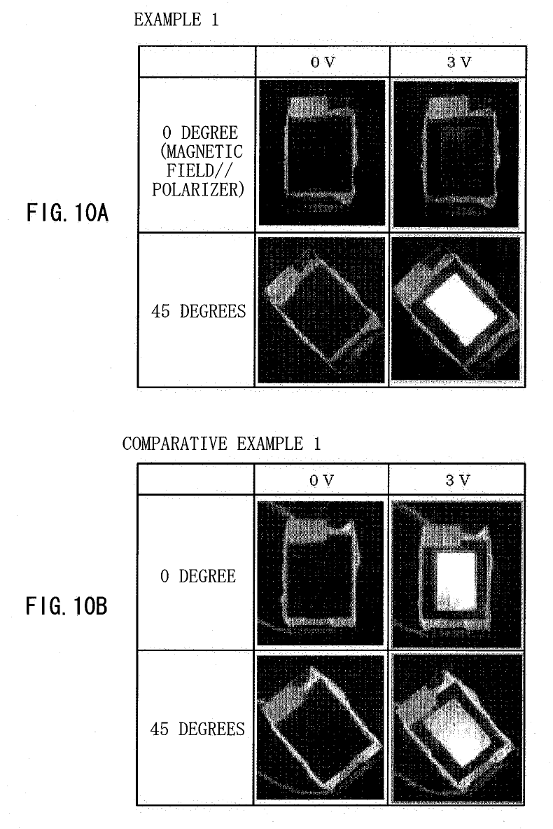

FIG. 10A shows change of an external appearance of the liquid crystal cell 9 in the case where a voltage applied to the liquid crystal cell 9 of

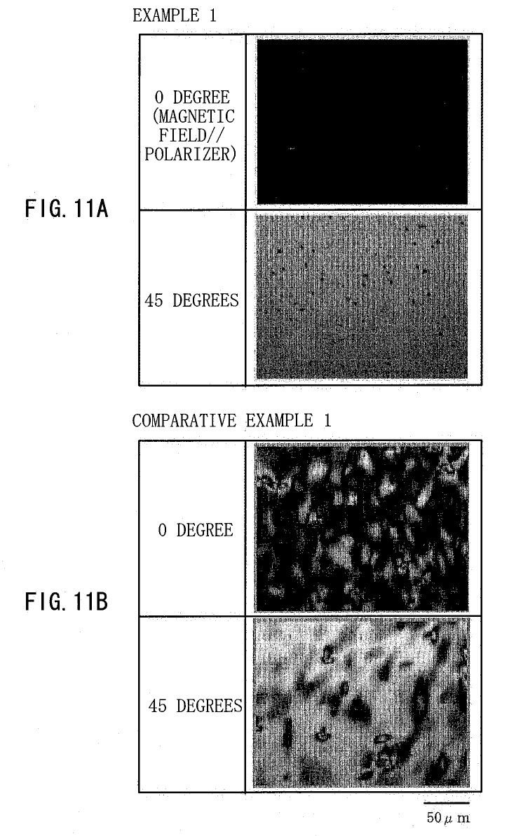

Example 1 was turned on and off. FIG. 11A shows observation images of the liquid crystal cell 9 by a polarization microscope in the case where 3V voltage was applied to the liquid crystal cell 9 of Example 1. FIG. 10B shows change of an external appearance of the liquid crystal cell in the case where a voltage applied to the liquid crystal cell of Comparative example 1 was turned on and off. FIG. 11B shows observation images of the liquid crystal cell by a polarization microscope in the case where 3V voltage was applied to the liquid crystal cell of Comparative example 1.

In the liquid crystal cell 9 of Example 1, in the case where the magnetic field application direction corresponded with the direction of an absorption axis of the polarization plate, light was extinguished, and in the case where the cell was rotated by 45 degree, it became bright. Therefore, it is conceivable that the display-use liquid crystal molecules 11 were tilted to the in-plane orientation including the substrate normal line direction and the magnetic field application direction by applying the voltage. Meanwhile, in the liquid crystal cell of Comparative example 1, even when the liquid crystal cell was rotated, the light transmission factor of the liquid crystal cell was not changed, and there was no measurement position where light was extinguished. Therefore, it is conceivable that the display-use liquid crystal molecules 11 were tilted in various orientations by applying the voltage.

Meanwhile, in the case where the liquid crystal cell formed in Comparative examples 2 and 3 was observed by a polarization microscope, there was tone partially, and in the case where the sample was rotated, the tone was changed as well. Therefore, it is conceivable that the display-use liquid crystal molecules 11 were not aligned vertically, but were tilted horizontally in various directions.

### Measurement of Retardation of Liquid Crystal Cell

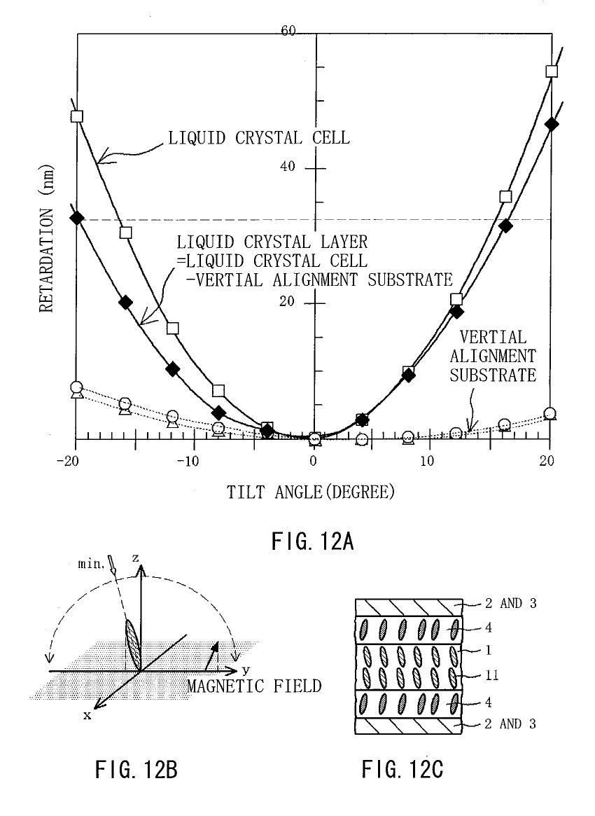

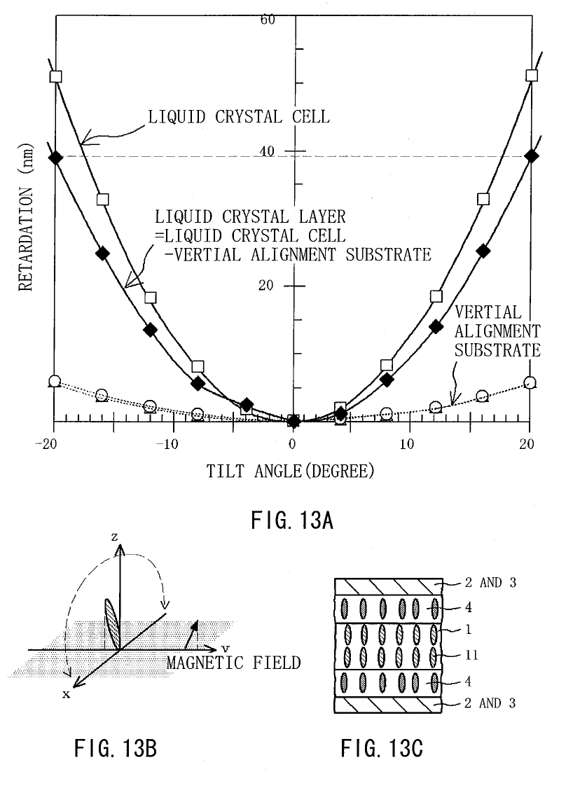

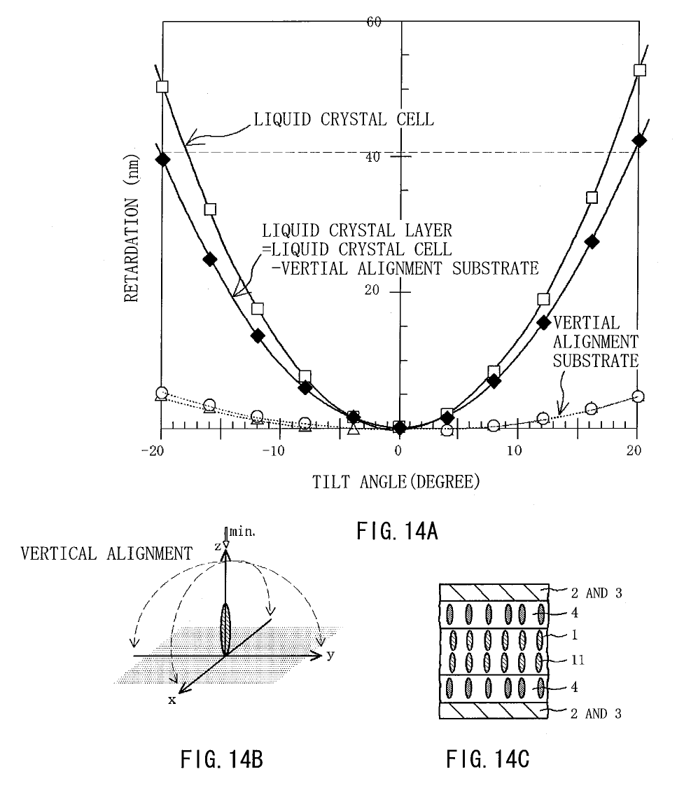

For the liquid crystal cell 9 of Example 1 and the liquid crystal cell of Comparative example 1, the retardation characteristics were measured by variously changing a tilt angle in the same manner as that of the vertical alignment substrate. FIGS. 12A and 13A are a graph showing measurement results of the liquid crystal cell 9 of Example 1, FIGS. 12B and 13B are an explanation diagram showing the measurement direction, and FIGS. 12C and 13C are a cross sectional view of the liquid crystal cell. FIG. 14A is a graph showing measurement results of the liquid crystal cell of Comparative example 1, FIG. 14B is an explanation diagram showing the measurement direction, and FIG. 14C is a cross sectional view of the liquid crystal cell.

As shown in FIG. 14A, in the liquid crystal cell of Comparative example 1, even when the tilt angle was changed in any plane including the substrate normal line direction (refer to FIG. 14B), the substantially same result was obtained. That is, retardation of the liquid crystal cell was the minimum value 0 in the case where the tilt angle was 0 degree, and retardation was increased symmetrically in the case where the tilt angle was changed in either positive direction or the negative direction from such a direction. For retardation of the liquid crystal layer composed of the display-use liquid crystal molecules 11 obtained by subtracting the retardation of the vertical alignment substrate previously measured from the retardation of the liquid crystal cell, similar tendency was shown. It shows that, as shown in FIG. 14B, the crystalline framework of the polymerizable liquid crystal molecules 12 and the polymer 13 thereof that was aligned vertically to the transparent substrate 2 controlled the display-use liquid crystal molecules 11 to be aligned vertically to the transparent substrate 2. When the pretilt angle was evaluated by crystal rotation method, it was found that the tilt angle was 90 degree and the display-use liquid crystal molecules 11 were not tilted from the substrate normal line direction.

Meanwhile, as shown in FIG. 12A and FIG. 13A, in the liquid crystal cell of Example 1, the result in the case where the tilt angle was changed in the plane (yz plane) including the substrate normal line direction and the magnetic field application direction was different from the result in the case where the tilt angle was changed in the xz plane perpendicular to the yz plane (refer to FIG. 12B and FIG. 13B).

That is, in the yz plane including the magnetic field application direction, as shown in FIG. 12A, retardation of the liquid crystal cell was the minimum value in the case where the tilt angle was negative, and retardation was increased in the case where the tilt angle was changed in either positive direction or the negative direction from such a direction. For retardation of the liquid crystal layer composed of the display-use liquid crystal molecules 11 obtained by subtracting the retardation of the vertical alignment substrate previously measured from the retardation of the liquid crystal cell, the angle at which the retardation was the minimum value was shifted to the negative direction, not symmetrical to the tilt angle. The result shows that, as shown in FIG. 12B, the display-use liquid crystal molecules 11 were aligned tilted to the opposite side of the direction to which the crystalline framework of the polymerizable liquid crystal molecules 12 and the polymer 13 thereof was tilted to the normal line direction of the transparent substrate 2. The pretilt angle of the display-use liquid crystal molecules 11 was evaluated by crystal rotation method. As a result, the pretilt angle was 88.8 degree. Therefore, it was found that the display-use liquid crystal molecules 11 were tilted by 1.2 degree from the substrate normal line direction. For Example 2, similar evaluation was performed. As a result, it was found that the pretilt angle was 88.9 degree, and the display-use liquid crystal molecules 11 were tilted by 1.1 degree from the substrate normal line direction.

Meanwhile, in the xz plane, as shown in FIG. 13A, retardation of the liquid crystal cell was the minimum value in the case where the tilt angle was 0 degree, and retardation was increased symmetrically in the case where the tilt angle was changed in either positive direction or the negative direction from such a direction. The result showed that, as shown in FIG. 13B, the display-use liquid crystal molecules 11 were not tilted to the x-axis direction.

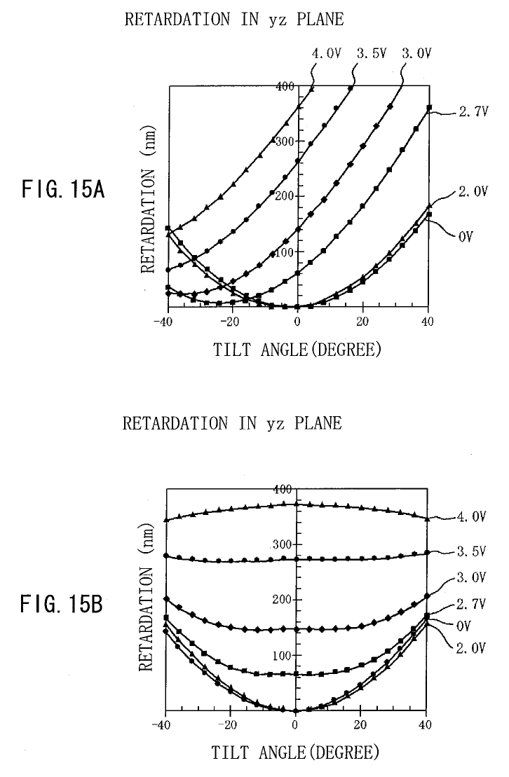

FIGS. 15A and 15B are graphs showing results of measuring retardation while voltage was applied for the liquid crystal cell of Example 1. It is found from FIG. 15A that the larger the applied voltage was, the larger the tilt from the normal line direction of the display-use liquid crystal molecules 11 was, and that the tilt direction was the direction in which the display-use liquid crystal molecules 11 was tilted by action of the vertical alignment film 4 when a voltage was not applied. FIG. 15B shows characteristics that even when the applied voltage was larger, retardation was symmetrical to the tilt angle.

Accordingly, it was shown that by using the vertical alignment film 4 formed by applying a magnetic field, the display-use liquid crystal molecules 11 was able to be tilted in the plane including the substrate normal line direction and the magnetic field application direction when a voltage was not applied to the liquid crystal cell 9. It was also shown that as a result thereof, when a voltage was applied to the liquid crystal cell 9, the tilt orientation of the display-use liquid crystal molecules 11 was able to be controlled.

### Example 3

In Example 3, the vertical alignment substrate 25 including the vertical alignment film 24 and the liquid crystal cell 29 that have been described by using FIGS. 5A and 5B in the second embodiment were formed.

In Example 3, in forming the vertical alignment substrate 25, the vertical alignment film 24 having a repeating pattern including four areas with a different tilt orientation of the polymerizable liquid crystal molecules 12 in an area being 560 μm long and 200 μm wide was formed by using a photo mask having a repeating pattern provided with four translucent sections being 270 μm long and 90 μm wide corresponding to one domain in an area being 560 μm long and 200 μm wide corresponding to one pixel and by irradiating with parallel ultraviolet ray while changing the position of the photo mask and the magnetic field application orientation (45, 135, 225, and 315 degree). Except for it, the vertical alignment substrate 25 was formed in the same manner as that of Example 1. Two pieces of the vertical alignment substrates 25 were used to form the liquid crystal cell 29 in the same manner as that of Example 1.

In the liquid crystal cell 29, the display-use liquid crystal molecules 11 in each area were tilted to four orientations different from each other by applying a voltage. The orientations were opposite direction of the magnetic field application direction in forming the vertical alignment film 24 in relation to the normal line direction of the substrate face. That is, a multidomain structure was able to be formed by using the magnetic field orientation and the photo mask.

While the present application has been described with reference to the embodiments and the examples, the present application is not limited to the foregoing examples, and various modifications may be made as appropriate within the scope of the present application. For example, the vertical alignment film of the present application is able to be applied to a liquid crystal device including existing various structures.

The vertical alignment film, the vertical alignment substrate, and the liquid crystal display device according to the present application are able to contribute to improving the performance of many liquid crystal display units using a liquid crystal display device such as a liquid crystal television.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A vertical alignment film that is provided to be contacted with a display-use liquid crystal molecule layer for at least one of substrates in a liquid crystal display device having the display-use liquid crystal molecule layer and the substrates arranged with the display-use liquid crystal molecule layer in between, and that controls an alignment direction of display-use liquid crystal molecules in the display-use liquid crystal molecule layer approximately vertically to a substrate face of the substrate, wherein
the vertical alignment film is formed from a layer composed of polymerizable liquid crystal molecules that have a crystalline framework, and have characteristics to align a director (alignment vector) vertically to an interface with a dissimilar material and polymerizable characteristics,
at least part of the polymerizable liquid crystal molecules is polymerized in the case where the layer composed of the polymerizable liquid crystal molecules is in a state of liquid crystal and in a state that the director is aligned in a direction slightly tilted from a normal line direction of the substrate face, the layer composed of the polymerizable liquid crystal molecules is changed into a layer formed from a complex composed of the unreacted polymerizable liquid crystal molecules and a polymerizable liquid crystal molecule polymer and hardened, and thereby the vertical alignment film is formed, and
the alignment direction of the director in the complex is fixed in the direction slightly tilted from the normal line direction of the substrate face.

2. The vertical alignment film according to claim 1, wherein the layer composed of the polymerizable liquid crystal molecules is a layer that has been once in a state of liquid crystal in which the director is aligned vertically to the substrate face and then has changed to the state in which the director is aligned in the direction slightly tilted from the normal line direction of the substrate face.

3. The vertical alignment film according to claim 1, wherein the alignment direction of the director in the complex is a direction tilted by 0.1 to 20 degrees from the normal line direction of the substrate face.

4. The vertical alignment film according to claim 3, wherein the alignment direction of the director in the complex is a direction tilted by 1 to 10 degrees from the normal line direction of the substrate face.

5. The vertical alignment film according to claim 4, wherein the alignment direction of the director in the complex is a direction tilted by 1 to 5 degrees from the normal line direction of the substrate face.

6. The vertical alignment film according to claim 1, wherein the polymerizable liquid crystal molecules have at least one functional group selected from the group consisting of an acryloyloxy group, a methacryloyloxy group, a vinyl ether group, and an epoxy group as a polymerizable functional group.

7. The vertical alignment film according to claim 1, wherein the polymerizable liquid crystal molecules are molecules having large magnetic susceptibility anisotropy.

8. The vertical alignment film according to claim 7, wherein the polymerizable liquid crystal molecules are molecules having an aromatic ring.

9. The vertical alignment film according to claim 1, wherein in each pixel, the layer composed of the complex is formed as a pattern composed of a plurality of regions in which a tilt direction of the director is different from each other.

10. The vertical alignment film according to claim 1 that aligns the display-use liquid crystal molecules in a direction tilted by 0.1 to 5 degrees from the normal line direction of the substrate.

11. The vertical alignment film according to claim 10 that aligns the display-use liquid crystal molecules in a direction tilted by 0.5 to 2.5 degrees from the normal line direction of the substrate.

12. The vertical alignment film according to claim 11 that aligns the display-use liquid crystal molecules in a direction tilted by 0.8 to 1.5 degrees from the normal line direction of the substrate.

13. The vertical alignment film according to claim 1 that aligns the display-use liquid crystal molecules tilted in the opposite direction of the alignment direction of the director in relation to the normal line direction of the substrate face.

14. A method of forming a vertical alignment film that is provided to be contacted with a display-use liquid crystal molecule layer for at least one of substrates in a liquid crystal display device having the display-use liquid crystal molecule layer and the substrates arranged with the display-use liquid crystal molecule layer in between, and that controls an alignment direction of display-use liquid crystal molecules in the display-use liquid crystal molecule layer approximately vertically to a substrate face of the substrate, the method comprising:
forming a layer composed of polymerizable liquid crystal molecules that have a crystalline framework, and have characteristics to align a director (alignment vector) vertically to an interface with a dissimilar material and polymerizable characteristics for the substrate;
aligning the director in a direction slightly tilted from a normal line direction of the substrate face while keeping the layer composed of the polymerizable liquid crystal molecules in a state of liquid crystal; and
polymerizing at least part of the polymerizable liquid crystal molecules in the foregoing state that the director is aligned, changing the layer composed of the polymerizable liquid crystal molecules into a layer formed from a complex composed of the unreacted polymerizable liquid crystal molecules and a polymerizable liquid crystal molecule polymer and hardening the layer, wherein
as the vertical alignment film, the layer composed of the complex in which the alignment direction of the director is fixed in the direction slightly tilted from the normal line direction of the substrate face is formed.

15. The method of forming a vertical alignment film according to claim 14, wherein before the step of aligning the director, a treatment for making the polymerizable liquid crystal molecules come into a state of liquid crystal in which the director is aligned vertically to the substrate face in the layer composed of the polymerizable liquid crystal molecules.

16. The method of forming a vertical alignment film according to claim 15, wherein after the step of forming the layer composed of the polymerizable liquid crystal molecules and before the step of aligning the director, a step of increasing temperature of the layer composed of the polymerizable liquid crystal molecules, thereby once making the polymerizable liquid crystal molecules come into a state of isotropic phase, and then gradually lowering the temperature of the layer composed of the polymerizable liquid crystal molecules, and thereby making the polymerizable liquid crystal molecules come into a state of liquid crystal in which the director is aligned vertically to the substrate face is performed.

17. The method of forming a vertical alignment film according to claim 14, wherein the director in the layer composed of the polymerizable liquid crystal molecules is aligned in a direction tilted by 0.1 to 20 degrees from the normal line direction of the substrate face.

18. The method of forming a vertical alignment film according to claim 17, wherein the director in the layer composed of the polymerizable liquid crystal molecules is aligned in a direction tilted by 1 to 10 degrees from the normal line direction of the substrate face.

19. The method of forming a vertical alignment film according to claim 18, wherein the director in the layer composed of the polymerizable liquid crystal molecules is aligned in a direction tilted by 1 to 5 degrees from the normal line direction of the substrate face.

20. The method of forming a vertical alignment film according to claim 14, wherein the polymerizable liquid crystal molecules are polymerized by irradiation of ultraviolet ray, infrared ray, or electron ray, and/or heating.

21. The method of forming a vertical alignment film according to claim 20, wherein as the polymerizable liquid crystal molecules, molecules having at least one functional group selected from the group consisting of an acryloyloxy group, a methacryloyloxy group, a vinyl ether group, and an epoxy group as a polymerizable functional group are used.

22. The method of forming a vertical alignment film according to claim 14, wherein the director is aligned in the direction slightly tilted from the normal line direction of the substrate by applying a magnetic field to the layer composed of the polymerizable liquid crystal molecules kept in the state of liquid crystal.

23. The method of forming a vertical alignment film according to claim 22, wherein as the polymerizable liquid crystal molecules, molecules having large magnetic susceptibility anisotropy are used.

24. The method of forming a vertical alignment film according to claim 22, wherein as the polymerizable liquid crystal molecules, molecules having an aromatic ring are used.

25. The method of forming a vertical alignment film according to claim 14, wherein a step of polymerizing the polymerizable liquid crystal molecules in partial regions in each pixel by radiation of ultraviolet ray, infrared ray, or electron ray with the use of a photo mask is performed for every plurality of regions in a pixel while changing an application direction of a magnetic field, and thereby in each pixel, the layer composed of the complex is formed as a pattern composed of a plurality of regions in which a tilt direction of the director is different from each other.

26. A vertical alignment substrate arranged to be contacted with a display-use liquid crystal molecule layer of a liquid crystal display device, wherein
a vertical alignment film is provided on a face side contacted with the display-use liquid crystal molecule layer,
the vertical alignment film is formed from a layer composed of polymerizable liquid crystal molecules having a crystalline framework, and having characteristics to align a director (alignment vector) vertically to an interface with a dissimilar material and polymerizable characteristics,
at least part of the polymerizable liquid crystal molecules is polymerized in the case where the layer composed of the polymerizable liquid crystal molecules is in a state of liquid crystal and in a state that the director is aligned in a direction slightly tilted from a normal line direction of the substrate face, the layer composed of the polymerizable liquid crystal molecules is changed into a layer formed from a complex composed of the unreacted polymerizable liquid crystal molecules and a polymerizable liquid crystal molecule polymer and hardened, and thereby the vertical alignment film is formed, and
the alignment direction of the director in the complex is fixed in the direction slightly tilted from the normal line direction of the substrate face.

27. A method of manufacturing a vertical alignment substrate arranged to be contacted with a display-use liquid crystal molecule layer of a liquid crystal display device, the method including:
forming a vertical alignment film on a face side contacted with the display-use liquid crystal molecule layer, the method of forming the vertical alignment film including the steps of
forming a layer composed of polymerizable liquid crystal molecules that have a crystalline framework, and have characteristics to align a director (alignment vector) vertically to an interface with a dissimilar material and polymerizable characteristics for the substrate,
aligning the director in a direction slightly tilted from a normal line direction of the substrate face while keeping the layer composed of the polymerizable liquid crystal molecules in a state of liquid crystal, and
polymerizing at least part of the polymerizable liquid crystal molecules in the foregoing state that the director is aligned, changing the layer composed of the polymerizable liquid crystal molecules into a layer formed from a complex composed of the unreacted polymerizable liquid crystal molecules and a polymerizable liquid crystal molecule polymer and hardening the layer, wherein
as the vertical alignment film, the layer composed of the complex in which the alignment direction of the director is fixed in the direction slightly tilted from the normal line direction of the substrate face is formed.

28. A liquid crystal display device comprising:
a display-use liquid crystal molecule layer; and
substrates arranged oppositely with the display-use liquid crystal molecule layer in between,
wherein a vertical alignment film is provided for at least one of the substrates so that the vertical alignment film is contacted with the display-use liquid crystal molecule layer,
the vertical alignment film is formed from a layer composed of polymerizable liquid crystal molecules that have a crystalline framework, and have characteristics to align a director (alignment vector) vertically to an interface with a dissimilar material and polymerizable characteristics,
at least part of the polymerizable liquid crystal molecules is polymerized in the case where the layer composed of the polymerizable liquid crystal molecules is in a state of liquid crystal and in a state that the director is aligned in a direction slightly tilted from a normal line direction of the substrate face, the layer composed of the polymerizable liquid crystal molecules is changed into a layer formed from a complex composed of the unreacted polymerizable liquid crystal molecules and a polymerizable liquid crystal molecule polymer and hardened, and thereby the vertical alignment film is formed, and
an alignment direction of the display-use liquid crystal molecules when an electric field is not applied is controlled in a direction slightly tilted from a normal line direction of the substrate face.

29. The liquid crystal display device according to claim 28, wherein the vertical alignment film is provided for the both substrates, and an alignment direction of the director in each film located oppositely is in parallel with each other in the two vertical alignment films.

30. The liquid crystal display device according to claim 28, wherein the alignment direction of the display-use liquid crystal molecules when an electric field is not applied is a direction tilted by 0.1 to 5 degrees from the normal line direction of the substrate face.

31. The liquid crystal display device according to claim 30, wherein the alignment direction of the display-use liquid crystal molecules when an electric field is not applied is a direction tilted by 0.5 to 2.5 degrees from the normal line direction of the substrate face.

32. The liquid crystal display device according to claim 31, wherein the alignment direction of the display-use liquid crystal molecules when an electric field is not applied is a direction tilted by 0.8 to 1.5 degrees from the normal line direction of the substrate face.

33. The liquid crystal display device according to claim 28, wherein the alignment direction of the display-use liquid crystal molecules when an electric field is not applied is the opposite direction of an alignment direction of the director in the vertical alignment film in relation to the normal line of the substrate face.

34. The liquid crystal display device according to claim 28, wherein an optical compensated layer for compensating optical anisotropy generated by the vertical alignment film and the display-use liquid crystal molecules when an electric field is not applied is provided.

35. The liquid crystal display device according to claim 28 structured as a transmissive liquid crystal display device that forms a transmissive liquid crystal display unit in combination with a backlighting unit.
